(19) United States
(12) Patent Application Publication
(10) Pub. No.: US 2023/0420178 A1
(43) Pub. Date: Dec. 28, 2023

(54) INDUCTOR COMPONENT AND MANUFACTURING METHOD FOR INDUCTOR COMPONENT

(71) Applicant: Murata Manufacturing Co., Ltd., Kyoto-fu (JP)

(72) Inventors: Atsushi SEKO, Nagaokakyo-shi (JP); Masayuki YONEDA, Nagaokakyo-shi (JP)

(73) Assignee: Murata Manufacturing Co., Ltd., Kyoto-fu (JP)

(21) Appl. No.: 18/341,491

(22) Filed: Jun. 26, 2023

(30) Foreign Application Priority Data
Jun. 27, 2022 (JP) 2022-102971

(51) Int. Cl. H01F 27/29; H01F 27/28; H01F 41/04

(52) U.S. Cl. CPC H01F 27/292; H01F 27/2804; H01F 41/042; H01F 2027/2809

(57) ABSTRACT

To suppress interference between an inductor component and other electronic components, in the inductor component, the distance from the first end surface to the surface of the first covering electrode in the direction perpendicular to the first end surface is defined as the thickness of the first covering electrode. On a second virtual line that passes through a geometric center of the first end surface and is perpendicular to a first main surface, a position where the thickness of the first covering electrode is maximum is shifted toward the first main surface side with respect to the geometric center of the first end surface.

### CROSS-REFERENCE TO RELATED APPLICATION

This application claims benefit of priority to Japanese Patent Application No. 2022-102971, filed Jun. 27, 2022, the entire content of which is incorporated herein by reference.

### BACKGROUND

### Technical Field

The present disclosure relates to an inductor component and a manufacturing method for an inductor component.

### DETAILED DESCRIPTION

The inductor component described in Japanese Patent Application Laid-Open No. 2021-27250 includes an element body, an inductor wiring, a first covering electrode, and a second covering electrode. The element body has a rectangular parallelepiped shape having six outer surfaces. The inductor wiring extends inside the element body. The element body includes a first electrode and a second electrode. The first electrode is connected to a first end of the inductor wiring. The second electrode is connected to a second end of the inductor wiring. One of outer surfaces of the element body is defined as a main surface, one of surfaces perpendicular to the main surface is defined as a first end surface, a surface parallel to the first end surface is defined as a second end surface, and one of surfaces perpendicular to both the main surface and the first end surface is defined as a bottom surface. In this case, the first electrode is exposed to the outside of the element body in a region from the bottom surface to the first end surface. The second electrode is exposed to the outside of the element body in a region from the bottom surface to the second end surface. The first covering electrode covers the surface of the first electrode. The second covering electrode covers the surface of the second electrode.

### SUMMARY

The inductor component as described in Japanese Patent Application Laid-Open No. 2021-27250 is disposed on the substrate to be adjacent to other electronic components. Here, the thickness of the first covering electrode is not necessarily uniform on the first end surface, and the first covering electrode may protrude at a part in a direction in which the first end surface faces. When the first covering electrode excessively protrudes, the first covering electrode may interfere with other electronic components disposed to face the first end surface. In order to avoid such interference, it is necessary to secure a considerable space between the inductor component and other electronic components. Therefore, high-density mounting of the inductor component and other electronic components is hindered.

Accordingly, an aspect of the present disclosure is an Inductor component including: an element body having a rectangular parallelepiped shape having six outer surfaces; an inductor wiring extending inside the element body; a first covering electrode that covers a bottom surface, which is one of the outer surfaces, and is electrically connected to a first end of the inductor wiring; and a second covering electrode that covers the bottom surface and is electrically connected to a second end of the inductor wiring. When one of the six outer surfaces of the element body perpendicular to the bottom surface is defined as a main surface, and surfaces perpendicular to both the bottom surface and the main surface are defined as a first end surface and a second end surface, the first covering electrode and the second covering electrode cover a part of a first virtual line that passes through a geometric center of the bottom surface and is perpendicular to the first end surface, the first covering electrode covers the first end surface, and the second covering electrode covers the second end surface. Also, when a distance from the first end surface to a surface of the first covering electrode in a direction perpendicular to the first end surface is defined as a thickness of the first covering electrode, a position where the thickness of the first covering electrode is maximum is shifted toward a main surface side with respect to a geometric center of the first end surface on a second virtual line that passes through the geometric center of the first end surface and is perpendicular to the main surface.

For example, as other electronic components disposed so as to be adjacent to the first end surface of the inductor component, one in which an electrode is plated on the entire end surface of a rectangular parallelepiped element body can be mentioned. In such an electronic component, the thickness of the electrode is large at the center of the end surface. That is, in this type of electronic component, the center of the end surface of the element body is bulged. In addition, under the current situation where the outer diameter size of the electronic components is substantially standardized, the land patterns on the substrate on which the electronic components are arranged are aligned in order to achieve high-density mounting. That is, when viewed from a direction perpendicular to the main surface of the substrate, the geometric center of the first end surface of the inductor component and the geometric center of the end surface of another adjacent electronic component are often aligned in the same straight line and adjacent to each other.

According to the above configuration, the position where the thickness of the first covering electrode is the maximum is shifted toward the main surface side with respect to the geometric center of the first end surface. Therefore, when the inductor component and the other electronic component are arranged at adjacent positions of the aligned land patterns on the substrate, the position where the thickness of the first covering electrode of the inductor component is the maximum and the position where the thickness of the electrode of the other electronic component is the maximum are shifted from each other, so that the electrodes of the both components hardly interfere with each other. Therefore, it is possible to contribute to densification of components on the substrate.

Another aspect of the present disclosure is a method for manufacturing an inductor component, including a laminate forming step of forming, using a conductive paste containing an insulating paste having an insulating property and metal powder, a laminate having a rectangular parallelepiped shape, the laminate including a pattern of the conductive paste extending spirally inside the insulating paste, a first conductive portion of the conductive paste connected to a first end of the pattern and exposed from the insulating paste, and a second conductive portion of the conductive paste connected to a second end of the pattern and exposed from the insulating paste. The method further comprises a firing step of firing the laminate to form an element body including a first buried electrode in which the first conductive portion is sintered and a second buried electrode in which the second conductive portion is sintered; and a plating step of plating surfaces of the first buried electrode and the second buried electrode exposed to a surface of the element body to form a first covering electrode covering the surface of the first buried electrode and a second covering electrode covering the surface of the second buried electrode. When one of six outer surfaces of the element body is defined as a bottom surface, one of surfaces perpendicular to the bottom surface is defined as a main surface, and surfaces perpendicular to both the bottom surface and the main surface are defined as a first end surface and a second end surface, the first buried electrode and the second buried electrode are exposed to an outside of the element body on the bottom surface, and the first buried electrode includes an end surface electrode portion exposed to the outside of the element body at the first end surface. Also, in the plating step, a geometric center of the first end surface is covered with a cover having an insulating property, and plating is performed by exposing a portion of the end surface electrode portion on the main surface side with respect to the geometric center from the cover on a virtual line that passes through the geometric center of the first end surface and is perpendicular to the main surface.

According to the above configuration, when electroplating is performed on the end surface electrode portion, electroplating is not performed at the geometric center because no current flows through the cover. Therefore, by electroplating only the portion on the main surface side with respect to the geometric center on the virtual line, the first covering electrode can be formed only in the portion on the main surface side with respect to the geometric center on the end surface electrode portion. As a result, the position where the thickness of the first covering electrode is the maximum has a shape shifted toward the main surface side with respect to the geometric center of the first end surface.

It is possible to suppress interference between the inductor component and other electronic components.

### BRIEF DESCRIPTION OF THE DRAWINGS

FIG. 1 is a perspective view of an inductor component of a first embodiment;

FIG. 2 is an exploded perspective view of the inductor component of the first embodiment;

FIG. 3 is a plan view of a first layer of the first embodiment;

FIG. 4 is an end view of the inductor component of the first embodiment;

FIG. 5 is a sectional view taken along line 5-5 in FIG. 4;

FIG. 6 is an explanatory diagram for explaining a method for manufacturing the inductor component of the first embodiment;

FIG. 7 is an exploded perspective view of an inductor component of a second embodiment;

FIG. 8 is an end view of the inductor component of the second embodiment;

FIG. 9 is a sectional view taken along line 9-9 in FIG. 8;

FIG. 10 is an end view of an inductor component of a modification;

FIG. 11 is an end view of an inductor component of a modification;

FIG. 12 is an end view of an inductor component of a modification;

FIG. 13 is an end view of an inductor component of a modification;

FIG. 14 is an end view of an inductor component of a modification;

FIG. 15 is an end view of an inductor component of a modification;

FIG. 16 is an end view of an inductor component of a modification; and

FIG. 17 is an end view of an inductor component of a modification.

### DETAILED DESCRIPTION

### First Embodiment

In the following, a first embodiment according to an inductor component will be described. The drawings may show enlarged components to facilitate understanding. The dimensional ratios of the components may be different from the actual ones or those in another drawing.

(Overall Configuration of Inductor Component)

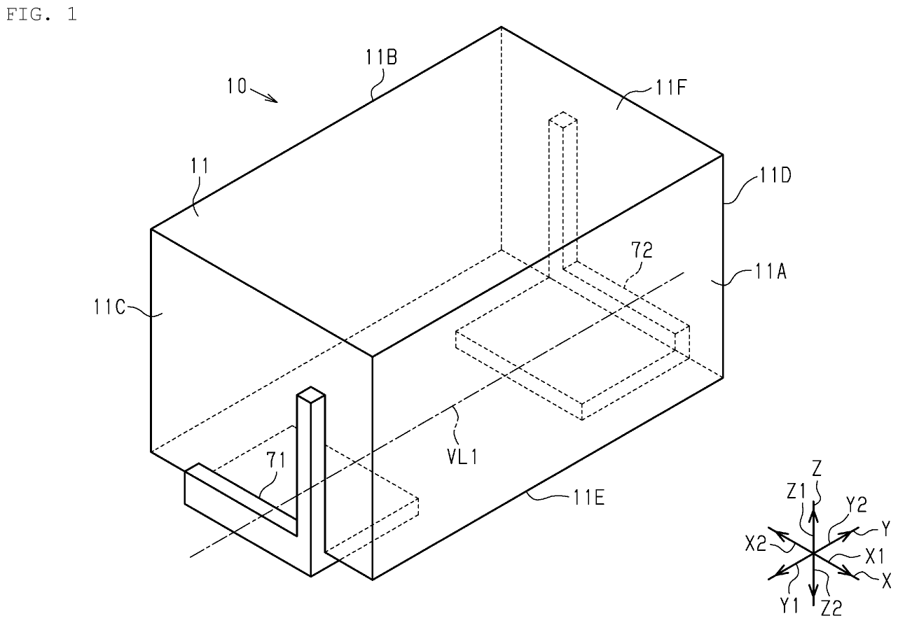

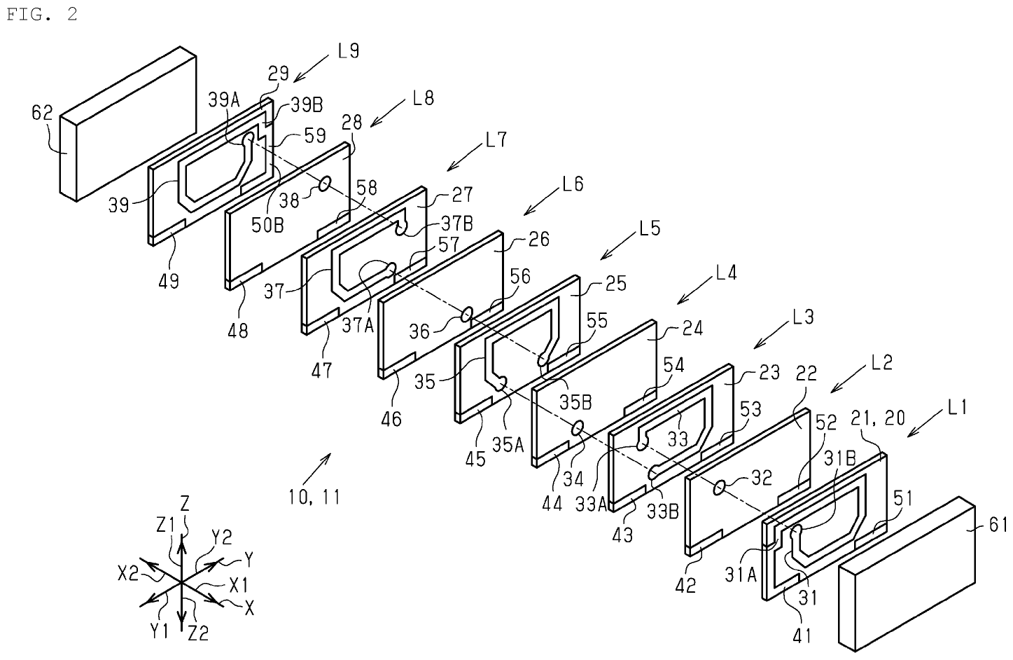

As illustrated in FIG. 1, an inductor component 10 includes a rectangular parallelepiped element body 11. As illustrated in FIGS. 2 and 3, the inductor component 10 includes an inductor wiring 30 extending inside the element body 11. The element body 11 includes a first buried electrode 40 connected to a first end of the inductor wiring 30 and a second buried electrode 50 connected to a second end of the inductor wiring 30.

As illustrated in FIG. 2, the element body 11 has a structure in which a plurality of plate-shaped layers are laminated as a whole. Each layer has a rectangular shape in plan view. Since the element body 11 has a rectangular parallelepiped shape, it has six planar outer surfaces. As illustrated in FIG. 1, one of these six outer surfaces is defined as a bottom surface 11E. Among the six outer surfaces, one surface perpendicular to the bottom surface 11E is defined as a first main surface 11A. A surface parallel to the first main surface 11A is defined as a second main surface 11B. One of the surfaces perpendicular to both the bottom surface 11E and the first main surface 11A is defined as a first end surface 11C. A surface parallel to the first end surface 11C is defined as a second end surface 11D. A surface parallel to the bottom surface 11E is defined as a top surface 11F.

In the following description, an axis along a direction in which a plurality of layers are laminated, that is, an axis perpendicular to the first main surface 11A is referred to as a first axis X. An axis perpendicular to the first end surface 11C is defined as a second axis Y. Further, an axis perpendicular to the bottom surface 11E is defined as a third axis Z. Of the directions along the first axis X, a direction in which the first main surface 11A faces is defined as a first positive direction X1, and a direction opposite to the first positive direction X1 is defined as a first negative direction X2. Of the directions along the second axis Y, a direction in which the first end surface 11C faces is defined as a second positive direction Y1, and a direction opposite to the second positive direction Y1 is defined as a second negative direction Y2. Furthermore, among the directions along the third axis Z, a direction in which the top surface 11F faces is defined as a third positive direction Z1, and a direction opposite to the third positive direction Z1 is defined as a third negative direction Z2.

As illustrated in FIG. 2, the element body 11 includes a first layer L1 to a ninth layer L9. The first layer L1 to the ninth layer L9 are arranged in this order in the first negative direction X2. The thicknesses of the first layer L1 to the ninth layer L9, that is, the dimensions in the direction along the X axis are all substantially the same. As illustrated in FIG. 3, the first layer L1 includes a first electrode portion 41, a second electrode portion 51, a first wiring portion 31, and a first insulating portion 21.

The first electrode portion 41 is made of a conductive material such as silver. When the first layer L1 is viewed in the first negative direction X2, the first electrode portion 41 has an L shape as a whole. When the first layer L1 is viewed in the first negative direction X2, the first electrode portion 41 is located on the second positive direction Y1 side and the third negative direction Z2 side with respect to the center of the first layer L1. More specifically, when the first layer L1 is viewed in the first negative direction X2, the first electrode portion 41 is located at a position including a corner on the second positive direction Y1 side and the third negative direction Z2 side of the first layer L1.

The second electrode portion 51 is made of a conductive material such as silver. The second electrode portion 51 has a rod shape. The second electrode portion 51 extends along the bottom surface 11E. An end of the second electrode portion 51 on the second negative direction Y2 side is located on the second end surface 11D. An end of the second electrode portion 51 on the second positive direction Y1 side is located on the second negative direction Y2 side with respect to the center of the bottom surface 11E in the direction along the second axis Y.

The first wiring portion 31 is made of a conductive material such as silver. When the first layer L1 is viewed in the first negative direction X2, the first wiring portion 31 extends as a whole in a spiral shape with the center of the first layer L1 as a substantial center. Specifically, a first end portion 31A of the first wiring portion 31 is connected to an end portion of the first electrode portion 41 on the third positive direction Z1 side in the direction along the third axis Z. The first end portion 31A is a portion deviated from the circling path configured by overlapping the wiring portions of the first layer L1 to the ninth layer L9 when viewed in the first negative direction X2. That is, the first end portion 31A is the first end of the inductor wiring 30. The wiring width of the first wiring portion 31 is substantially constant except for a second end portion 31B. The position of the second end portion 31B of the first wiring portion 31 in the direction along the third axis Z is on the third positive direction Z1 side from the center of the first layer L1 in the direction along the third axis Z. The position of the second end portion 31B of the first wiring portion 31 in the direction along the second axis Y is on the second positive direction Y1 side from the center of the first layer L1 in the direction along the second axis Y. When the first wiring portion 31 is viewed in the first negative direction X2, the first wiring portion 31 extends clockwise from the first end portion 31A toward the second end portion 31B.

The second end portion 31B of the first wiring portion 31 functions as a pad for connection with a via 32 to be described later. When the first layer L1 is viewed in the first negative direction X2, the second end portion 31B has a substantially circular shape. The second end portion 31B of the first wiring portion 31 has a wiring width larger than that of the other portion of the first wiring portion 31.

In the first layer L1, a portion excluding the first electrode portion 41, the second electrode portion 51, and the first wiring portion 31 is the first insulating portion 21. The first insulating portion 21 is made of a nonmagnetic insulator such as glass, resin, or alumina.

As illustrated in FIG. 2, the second layer L2 is laminated on the main surface of the first layer L1 facing the first negative direction X2. When the second layer L2 is viewed in the first negative direction X2, the second layer L2 has the same rectangular shape as the first layer L1. The second layer L2 includes a third electrode portion 42, a fourth electrode portion 52, the via 32, and a second insulating portion 22.

The third electrode portion 42 is made of the same material as the first electrode portion 41. The third electrode portion 42 has a rod shape. The third electrode portion 42 extends along the bottom surface 11E. An end of the third electrode portion 42 on the second positive direction Y1 side is located on the first end surface 11C. An end of the third electrode portion 42 on the second negative direction Y2 side coincides with an end of the first electrode portion 41 on the second negative direction Y2 side. Therefore, when the second layer L2 is viewed in the first negative direction X2, the third electrode portion 42 is located at a portion and a position extending along the bottom surface 11E of the first electrode portion 41. Therefore, the third electrode portion 42 is laminated on the surface of the first electrode portion 41 facing the first negative direction X2.

The fourth electrode portion 52 is made of the same material as the second electrode portion 51. The fourth electrode portion 52 has a rod shape having the same dimension as the second electrode portion 51. When the second layer L2 is viewed in the first negative direction X2, the fourth electrode portion 52 is located at the same position as the second electrode portion 51. Therefore, the fourth electrode portion 52 is laminated on the surface of the second electrode portion 51 facing the first negative direction X2.

The via 32 is made of the same material as the first wiring portion 31. The via 32 has a columnar shape extending in the direction along the first axis X. The via 32 is laminated on a surface of the second end portion 31B of the first wiring portion 31 facing the first negative direction X2. Therefore, the via 32 is electrically connected to the second end portion 31B of the first wiring portion 31. The via 32 extends from the second end portion 31B of the first wiring portion 31 in the first negative direction X2.

In the second layer L2, a portion excluding the third electrode portion 42, the fourth electrode portion 52, and the via 32 is the second insulating portion 22. The second insulating portion 22 is made of a nonmagnetic insulator of the same material as the first insulating portion 21.

The third layer L3 is laminated on the main surface of the second layer L2 facing the first negative direction X2. When the third layer L3 is viewed in the first negative direction X2, the third layer L3 has the same rectangular shape as the first layer L1. The third layer L3 includes a fifth electrode portion 43, a sixth electrode portion 53, a second wiring portion 33, and a third insulating portion 23.

The fifth electrode portion 43 is made of the same material as the first electrode portion 41. The fifth electrode portion 43 has a rod shape having the same dimension as the third electrode portion 42. When the third layer L3 is viewed in the first negative direction X2, the fifth electrode portion 43 is located at the same position as the third electrode portion 42. Therefore, the fifth electrode portion 43 is laminated on the surface of the third electrode portion 42 facing the first negative direction X2.

The sixth electrode portion 53 is made of the same material as the second electrode portion 51. The sixth electrode portion 53 has a rod shape having the same dimension as the fourth electrode portion 52. When the third layer L3 is viewed in the first negative direction X2, the sixth electrode portion 53 is located at the same position as the fourth electrode portion 52. Therefore, the sixth electrode portion 53 is laminated on the surface of the fourth electrode portion 52 facing the first negative direction X2.

The second wiring portion 33 is made of the same material as the first wiring portion 31. When the third layer L3 is viewed in the first negative direction X2, the second wiring portion 33 extends as a whole in a spiral shape with the center of the third layer L3 as a substantial center. Specifically, the position of a first end portion 33A of the second wiring portion 33 is on the surface of the via 32 facing the first negative direction X2. Therefore, the first end portion 33A of the second wiring portion 33 is connected to the via 32. The wiring width of the second wiring portion 33 is substantially constant except for the first end portion 33A and a second end portion 33B. The position of the second end portion 33B of the second wiring portion 33 in the direction along the third axis Z is on the third negative direction Z2 side from the center of the third layer L3 in the direction along the third axis Z. The position of the second end portion 33B of the second wiring portion 33 in the direction along the second axis Y is on the second positive direction Y1 side from the center of the third layer L3 in the direction along the second axis Y. Furthermore, the position of the second end portion 33B of the second wiring portion 33 in the direction along the second axis Y is on the center side in the direction along the second axis Y with respect to the position of the second end portion 31B of the first wiring portion 31 in the direction along the second axis Y. When the second wiring portion 33 is viewed in the first negative direction X2, the second wiring portion 33 extends clockwise from the first end portion 33A toward the second end portion 33B.

In the third layer L3, a portion excluding the fifth electrode portion 43, the sixth electrode portion 53, and the second wiring portion 33 is the third insulating portion 23. The third insulating portion 23 is made of a nonmagnetic insulator of the same material as the first insulating portion 21.

The fourth layer L4 is laminated on the main surface of the third layer L3 facing the first negative direction X2. When the fourth layer L4 is viewed in the first negative direction X2, the fourth layer L4 has the same rectangular shape as the first layer L1. The fourth layer L4 includes a seventh electrode portion 44, an eighth electrode portion 54, a via 34, and a fourth insulating portion 24.

The seventh electrode portion 44 is made of the same material as the first electrode portion 41. The seventh electrode portion 44 has a rod shape having the same dimension as the fifth electrode portion 43. When the fourth layer L4 is viewed in the first negative direction X2, the seventh electrode portion 44 is located at the same position as the fifth electrode portion 43. Therefore, the seventh electrode portion 44 is laminated on the surface of the fifth electrode portion 43 facing the first negative direction X2.

The eighth electrode portion 54 is made of the same material as the second electrode portion 51. The eighth electrode portion 54 has a rod shape having the same dimension as the sixth electrode portion 53. When the fourth layer L4 is viewed in the first negative direction X2, the eighth electrode portion 54 is located at the same position as the sixth electrode portion 53. Therefore, the eighth electrode portion 54 is laminated on the surface of the sixth electrode portion 53 facing the first negative direction X2.

The via 34 is made of the same material as the first wiring portion 31. The via 34 has a columnar shape extending in the direction along the first axis X. The via 34 is laminated on a surface of the second end portion 33B of the second wiring portion 33 facing the first negative direction X2. Therefore, the via 34 is electrically connected to the second end portion 33B of the second wiring portion 33. The via 34 extends from the second end portion 33B of the second wiring portion 33 in the first negative direction X2.

In the fourth layer L4, a portion excluding the seventh electrode portion 44, the eighth electrode portion 54, and the via 34 is the fourth insulating portion 24. The fourth insulating portion 24 is made of a nonmagnetic insulator of the same material as the first insulating portion 21.

The fifth layer L5 is laminated on the main surface of the fourth layer L4 facing the first negative direction X2. When the fifth layer L5 is viewed in the first negative direction X2, the fifth layer L5 has the same rectangular shape as the first layer L1. The fifth layer L5 includes a ninth electrode portion 45, a tenth electrode portion 55, a third wiring portion 35, and a fifth insulating portion 25.

The ninth electrode portion 45 is made of the same material as the first electrode portion 41. The ninth electrode portion 45 has a rod shape having the same dimension as the seventh electrode portion 44. When the fifth layer L5 is viewed in the first negative direction X2, the ninth electrode portion 45 is located at the same position as the seventh electrode portion 44. Therefore, the ninth electrode portion 45 is laminated on the surface of the seventh electrode portion 44 facing the first negative direction X2.

The tenth electrode portion 55 is made of the same material as the second electrode portion 51. The tenth electrode portion 55 has a rod shape having the same dimension as the eighth electrode portion 54. When the fifth layer L5 is viewed in the first negative direction X2, the tenth electrode portion 55 is located at the same position as the second electrode portion 51. Therefore, the tenth electrode portion 55 is laminated on the surface of the eighth electrode portion 54 facing the first negative direction X2.

The third wiring portion 35 is made of the same material as the first wiring portion 31. When the fifth layer L5 is viewed in the first negative direction X2, the third wiring portion 35 as a whole extends in a spiral shape with the center of the fifth layer L5 as a substantial center. Specifically, the position of a first end portion 35A of the third wiring portion 35 is on the surface of the via 34 facing the first negative direction X2. Therefore, the first end portion 35A of the third wiring portion 35 is connected to the via 34. The wiring width of the third wiring portion 35 is substantially constant except for the first end portion 35A and a second end portion 35B. The position of the second end portion 35B of the third wiring portion 35 in the direction along the third axis Z is on the third negative direction Z2 side from the center of the fifth layer L5 in the direction along the third axis Z. The position of the second end portion 35B of the third wiring portion 35 in the direction along the second axis Y is on the second negative direction Y2 side from the center of the fifth layer L5 in the direction along the second axis Y. When the third wiring portion 35 is viewed in the first negative direction X2, the third wiring portion 35 extends clockwise from the first end portion 35A toward the second end portion 35B.

In the fifth layer L5, a portion excluding the ninth electrode portion 45, the tenth electrode portion 55, and the third wiring portion 35 is the fifth insulating portion 25. The fifth insulating portion 25 is made of a nonmagnetic insulator of the same material as the first insulating portion 21.

The sixth layer L6 is laminated on the main surface of the fifth layer L5 facing the first negative direction X2. When the sixth layer L6 is viewed in the first negative direction X2, the sixth layer L6 has the same rectangular shape as the first layer L1. The sixth layer L6 includes an eleventh electrode portion 46, a twelfth electrode portion 56, a via 36, and a sixth insulating portion 26.

The eleventh electrode portion 46 is made of the same material as the first electrode portion 41. The eleventh electrode portion 46 has a rod shape having the same dimension as the ninth electrode portion 45. When the sixth layer L6 is viewed in the first negative direction X2, the eleventh electrode portion 46 is located at the same position as the ninth electrode portion 45. Therefore, the eleventh electrode portion 46 is laminated on the surface of the ninth electrode portion 45 facing the first negative direction X2.

The twelfth electrode portion 56 is made of the same material as the second electrode portion 51. The twelfth electrode portion 56 has a rod shape having the same dimension as the tenth electrode portion 55. When the sixth layer L6 is viewed in the first negative direction X2, the twelfth electrode portion 56 is located at the same position as the tenth electrode portion 55. Therefore, the twelfth electrode portion 56 is laminated on the surface of the tenth electrode portion 55 facing the first negative direction X2.

The via 36 is made of the same material as the first wiring portion 31. The via 36 has a columnar shape extending in the direction along the first axis X. The via 36 is laminated on a surface of the second end portion 35B of the third wiring portion 35 facing the first negative direction X2. Therefore, the via 36 is electrically connected to the second end portion 35B of the third wiring portion 35. The via 36 extends from the second end portion 35B of the third wiring portion 35 in the first negative direction X2.

In the sixth layer L6, a portion excluding the eleventh electrode portion 46, the twelfth electrode portion 56, and the via 36 is the sixth insulating portion 26. The sixth insulating portion 26 is made of a nonmagnetic insulator of the same material as the first insulating portion 21.

The seventh layer L7 is laminated on the main surface of the sixth layer L6 facing the first negative direction X2. When the seventh layer L7 is viewed in the first negative direction X2, the seventh layer L7 has the same rectangular shape as the first layer L1. The seventh layer L7 includes a thirteenth electrode portion 47, a fourteenth electrode portion 57, a fourth wiring portion 37, and a seventh insulating portion 27.

The thirteenth electrode portion 47 is made of the same material as the first electrode portion 41. The thirteenth electrode portion 47 has a rod shape having the same dimension as the eleventh electrode portion 46. When the seventh layer L7 is viewed in the first negative direction X2, the thirteenth electrode portion 47 is located at the same position as the eleventh electrode portion 46. Therefore, the thirteenth electrode portion 47 is laminated on the surface of the eleventh electrode portion 46 facing the first negative direction X2.

The fourteenth electrode portion 57 is made of the same material as the second electrode portion 51. The fourteenth electrode portion 57 has a rod shape having the same dimension as the twelfth electrode portion 56. When the seventh layer L7 is viewed in the first negative direction X2, the fourteenth electrode portion 57 is located at the same position as the twelfth electrode portion 56. Therefore, the fourteenth electrode portion 57 is laminated on the surface of the twelfth electrode portion 56 facing the first negative direction X2.

The fourth wiring portion 37 is made of the same material as the first wiring portion 31. When the seventh layer L7 is viewed in the first negative direction X2, the fourth wiring portion 37 extends as a whole in a spiral shape with the center of the seventh layer L7 as a substantial center. Specifically, the position of a first end portion 37A of the fourth wiring portion 37 is on the surface of the via 36 facing the first negative direction X2. Therefore, the first end portion 37A of the fourth wiring portion 37 is connected to the via 36. The wiring width of the fourth wiring portion 37 is substantially constant except for the first end portion 37A and a second end portion 37B. The position of the second end portion 37B of the fourth wiring portion 37 in the direction along the third axis Z is on the third positive direction Z1 side from the center of the seventh layer L7 in the direction along the third axis Z. The position of the second end portion 37B of the fourth wiring portion 37 in the direction along the second axis Y is on the second negative direction Y2 side from the center of the seventh layer L7 in the direction along the second axis Y. Furthermore, the position of the second end portion 37B of the fourth wiring portion 37 in the direction along the second axis Y is on the second negative direction Y2 side with respect to the position of the first end portion 37A in the direction along the second axis Y. When the fourth wiring portion 37 is viewed in the first negative direction X2, the fourth wiring portion 37 extends clockwise from the first end portion 37A toward the second end portion 37B. The fourth wiring portion 37 is rotationally symmetric with the second wiring portion 33 with an axis in a direction along the third axis Z passing through the center in the extending direction of the inductor wiring 30 as a rotation axis.

In the seventh layer L7, a portion excluding the thirteenth electrode portion 47, the fourteenth electrode portion 57, and the fourth wiring portion 37 is the seventh insulating portion 27. The seventh insulating portion 27 is made of a nonmagnetic insulator of the same material as the first insulating portion 21.

The eighth layer L8 is laminated on the main surface of the seventh layer L7 facing the first negative direction X2. When the eighth layer L8 is viewed in the first negative direction X2, the eighth layer L8 has the same rectangular shape as the first layer L1. The eighth layer L8 includes a fifteenth electrode portion 48, a sixteenth electrode portion 58, a via 38, and an eighth insulating portion 28.

The fifteenth electrode portion 48 is made of the same material as the first electrode portion 41. The fifteenth electrode portion 48 has a rod shape having the same dimension as the thirteenth electrode portion 47. When the eighth layer L8 is viewed in the first negative direction X2, the fifteenth electrode portion 48 is located at the same position as the thirteenth electrode portion 47. Therefore, the fifteenth electrode portion 48 is laminated on the surface of the thirteenth electrode portion 47 facing the first negative direction X2.

The sixteenth electrode portion 58 is made of the same material as the second electrode portion 51. The sixteenth electrode portion 58 has a rod shape having the same dimension as the fourteenth electrode portion 57. When the eighth layer L8 is viewed in the first negative direction X2, the sixteenth electrode portion 58 is located at the same position as the fourteenth electrode portion 57. Therefore, the sixteenth electrode portion 58 is laminated on the surface of the fourteenth electrode portion 57 facing the first negative direction X2.

The via 38 is made of the same material as the first wiring portion 31. The via 38 has a columnar shape extending in the direction along the first axis X. The via 38 is laminated on a surface of the second end portion 37B of the fourth wiring portion 37 facing the first negative direction X2. Therefore, the via 38 is electrically connected to the second end portion 37B of the fourth wiring portion 37. The via 38 extends from the second end portion 37B of the fourth wiring portion 37 in the first negative direction X2.

In the eighth layer L8, a portion excluding the fifteenth electrode portion 48, the sixteenth electrode portion 58, and the via 38 is the eighth insulating portion 28. The eighth insulating portion 28 is made of a nonmagnetic insulator of the same material as the first insulating portion 21.

The ninth layer L9 is laminated on the main surface of the eighth layer L8 facing the first negative direction X2. When the ninth layer L9 is viewed in the first negative direction X2, the ninth layer L9 has the same rectangular shape as the first layer L1. The ninth layer L9 includes a seventeenth electrode portion 49, an eighteenth electrode portion 59, a fifth wiring portion 39, and a ninth insulating portion 29.

The seventeenth electrode portion 49 is made of the same material as the first electrode portion 41. The seventeenth electrode portion 49 has a rod shape having the same dimension as the fifteenth electrode portion 48. When the ninth layer L9 is viewed in the first negative direction X2, the seventeenth electrode portion 49 is located at the same position as the fifteenth electrode portion 48. Therefore, the seventeenth electrode portion 49 is laminated on the surface of the fifteenth electrode portion 48 facing the first negative direction X2.

The eighteenth electrode portion 59 is made of the same material as the second electrode portion 51. When the ninth layer L9 is viewed in the first negative direction X2, the eighteenth electrode portion 59 has an L shape as a whole. When the ninth layer L9 is viewed in the first negative direction X2, the eighteenth electrode portion 59 is located on the second negative direction Y2 side and the third negative direction Z2 side with respect to the center of the ninth layer L9. That is, when the first layer L1 is viewed in the first negative direction X2, the eighteenth electrode portion 59 is located at a position including a corner on the second negative direction Y2 side and the third negative direction Z2 side with respect to the center of the ninth layer L9. Therefore, the eighteenth electrode portion 59 is laminated on the surface of the sixteenth electrode portion 58 facing the first negative direction X2.

The fifth wiring portion 39 is made of the same material as the first wiring portion 31. When the ninth layer L9 is viewed in the first negative direction X2, the fifth wiring portion 39 extends as a whole in a spiral shape with the center of the ninth layer L9 as a substantial center. Specifically, the position of a first end portion 39A of the fifth wiring portion 39 is on the surface of the via 38 facing the first negative direction X2. Therefore, the first end portion 39A of the fifth wiring portion 39 is connected to the via 38. The wiring width of the fifth wiring portion 39 is substantially constant except for the first end portion 39A. A second end portion 39B of the fifth wiring portion 39 is connected to an end portion of the eighteenth electrode portion 59 on the third positive direction Z1 side in the direction along the third axis Z. When the fifth wiring portion 39 is viewed in the first negative direction X2, the fifth wiring portion 39 extends clockwise from the first end portion 39A toward the second end portion 39B. The second end portion 39B of the fifth wiring portion 39 is a second end portion of the inductor wiring 30. The second end portion 39B is a portion deviated from the circling path configured by overlapping the wiring portions of the first layer L1 to the ninth layer L9 when viewed in the first negative direction X2. The fifth wiring portion 39 is rotationally symmetric with the first wiring portion 31 with an axis in a direction along the third axis Z passing through the center in the extending direction of the inductor wiring 30 as a rotation axis.

In the ninth layer L9, a portion excluding the seventeenth electrode portion 49, the eighteenth electrode portion 59, and the fifth wiring portion 39 is the ninth insulating portion 29. The ninth insulating portion 29 is made of an insulator of the same material as that of the first insulating portion 21.

The element body 11 includes a first covering insulating layer 61 and a second covering insulating layer 62. When the first covering insulating layer 61 is viewed in the first negative direction X2, the first covering insulating layer 61 has the same rectangular shape as the first layer L1. The first covering insulating layer 61 is laminated on a main surface of the first layer L1 facing the first positive direction X1. When the second covering insulating layer 62 is viewed in the first positive direction X1, the second covering insulating layer 62 has the same rectangular shape as the first layer L1. The second covering insulating layer 62 is laminated on the main surface of the ninth layer L9 facing the first negative direction X2.

The first insulating portion 21 to the ninth insulating portion 29, the first covering insulating layer 61, and the second covering insulating layer 62 described above are integrated. Therefore, there is no physical boundary between them. Hereinafter, in a case where it is not necessary to distinguish these, they are collectively referred to as an insulating portion 20. The first insulating portion 21 to the ninth insulating portion 29, the first covering insulating layer 61, and the second covering insulating layer 62 may not be integrated. That is, there may be a physical boundary between them.

In addition, the first wiring portion 31, the second wiring portion 33, the third wiring portion 35, the fourth wiring portion 37, the fifth wiring portion 39, the via 32, the via 34, the via 36, and the via 38 are integrated. Therefore, there is no physical boundary between them. Hereinafter, in a case where it is not necessary to distinguish them, they are collectively referred to as the inductor wiring 30. The inductor wiring 30 is spirally wound as a whole. The central axis when the inductor wiring 30 is wound is an axis extending along the first axis X. Note that the first wiring portion 31, the second wiring portion 33, the third wiring portion 35, the fourth wiring portion 37, the fifth wiring portion 39, the via 32, the via 34, the via 36, and the via 38 may not be integrated. That is, there may be a physical boundary between them.

Furthermore, the first electrode portion 41, the third electrode portion 42, the fifth electrode portion 43, the seventh electrode portion 44, the ninth electrode portion 45, the eleventh electrode portion 46, the thirteenth electrode portion 47, the fifteenth electrode portion 48, and the seventeenth electrode portion 49 described above are integrated. Then, these are combined to form the first buried electrode 40.

Similarly, the second electrode portion 51, the fourth electrode portion 52, the sixth electrode portion 53, the eighth electrode portion 54, the tenth electrode portion 55, the twelfth electrode portion 56, the fourteenth electrode portion 57, the sixteenth electrode portion 58, and the eighteenth electrode portion 59 described above are integrated. Then, these are combined to form the second buried electrode 50.

In the present embodiment, the insulating portion 20, the first buried electrode 40, and the second buried electrode 50 constitute the element body 11 of the inductor component 10. As a result of laminating the first layer L1 to the ninth layer L9, the first covering insulating layer 61, and the second covering insulating layer 62, the element body 11 has a rectangular parallelepiped shape as a whole as illustrated in FIG. 1.

The inductor wiring 30 extends inside the element body 11. Note that the inductor wiring 30, the first buried electrode 40, and the second buried electrode 50 may be integrated. That is, there may be no physical boundary between the inductor wiring 30 and the first buried electrode 40 or between the inductor wiring 30 and the second buried electrode 50.

(Bottom Surface Electrode Portion and Protrusion Portion)

As illustrated in FIG. 3, the first buried electrode 40 is exposed to the outside of the element body 11 in a region from the first end surface 11C to the bottom surface 11E. The first buried electrode 40 includes a first bottom surface electrode portion 40A and a first end surface electrode portion 40B.

The first bottom surface electrode portion 40A is exposed to the outside of the element body 11 at the bottom surface 11E. The first bottom surface electrode portion 40A has a plate shape. When the bottom surface 11E is viewed in the third positive direction Z1, the first bottom surface electrode portion 40A has a quadrangular shape. The surface of the first bottom surface electrode portion 40A on the second positive direction Y1 side constitutes a part of the first end surface 11C of the element body 11.

The first end surface electrode portion 40B is exposed to the outside of the element body 11 at the first end surface 11C. The first end surface electrode portion 40B has a rod shape. The first end surface electrode portion 40B exists only in the first layer L1. The first end surface electrode portion 40B extends in the third positive direction Z1 from an end of the first bottom surface electrode portion 40A on the second positive direction Y1 side.

Similarly to the first buried electrode 40, as illustrated in FIG. 2, the second buried electrode 50 is exposed to the outside of the element body 11 in a region from the second end surface 11D to the bottom surface 11E. As illustrated in FIGS. 2 and 3, the second buried electrode 50 includes a second bottom surface electrode portion 50A and a second end surface electrode portion 50B.

The second bottom surface electrode portion 50A is exposed to the outside of the element body 11 at the bottom surface 11E. The second bottom surface electrode portion 50A has a plate shape. When the bottom surface 11E is viewed in the third positive direction Z1, the second bottom surface electrode portion 50A has a quadrangular shape. The surface of the second bottom surface electrode portion 50A on the second negative direction Y2 side constitutes a part of the second end surface 11D of the element body 11.

The second end surface electrode portion 50B is exposed to the outside of the element body 11 at the second end surface 11D. The second end surface electrode portion 50B has a rod shape. The second end surface electrode portion 50B exists only in the ninth layer L9. The second end surface electrode portion 50B extends in the third positive direction Z1 from an end of the second bottom surface electrode portion 50A on the second positive direction Y1 side.

(Covering Electrode)

As illustrated in FIG. 1, the inductor component 10 includes a first covering electrode 71 and a second covering electrode 72. The first covering electrode 71 and the second covering electrode 72 cover a part of a first virtual line VL1 that passes through the geometric center of the bottom surface 11E and is perpendicular to the first end surface 11C. The first covering electrode 71 covers a surface of the first buried electrode 40 exposed to the outside from the element body 11. Therefore, the first covering electrode 71 is electrically connected to the first end of the inductor wiring 30. The first covering electrode 71 covers the first end surface 11C at a part. Although not illustrated, the first covering electrode 71 has a two-layer structure of nickel plating and tin plating. In FIGS. 2 and 3, illustration of the first covering electrode 71 is omitted.

In addition, being exposed to the outside of the element body 11 means not being exposed to the outside of the inductor component 10 but being exposed from the element body 11. Therefore, if an electrode portion is covered with another member such as the first covering electrode 71, the electrode portion may not be exposed to the outside of the inductor component 10 as long as the electrode portion is exposed from the element body 11.

The distance from the first end surface 11C to the surface of the first covering electrode 71 in the direction perpendicular to the first end surface 11C is defined as the thickness of the first covering electrode 71. That is, the distance from the first end surface 11C to the surface of the first covering electrode 71 in the direction along the second axis Y is the thickness of the first covering electrode 71.

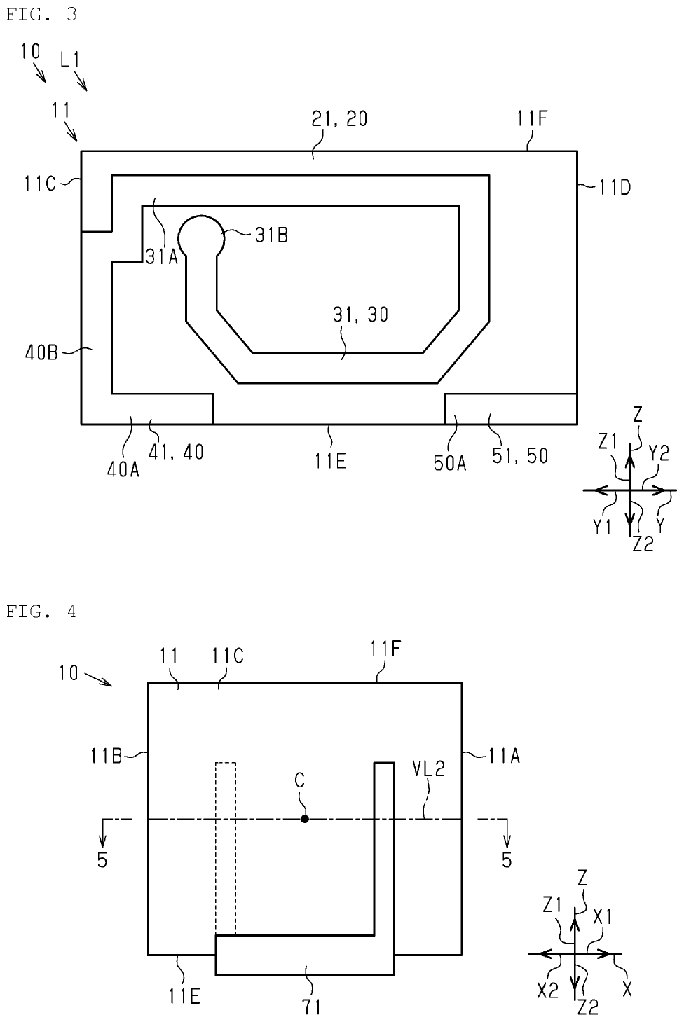

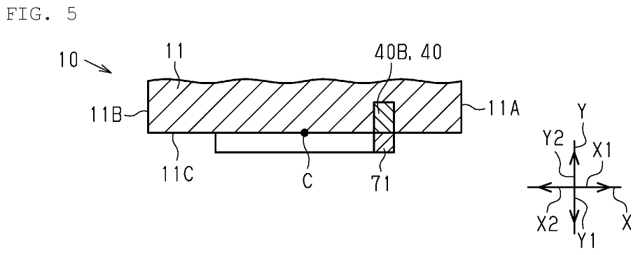

As illustrated in FIGS. 4 and 5, on a second virtual line VL2 that passes through a geometric center C of the first end surface 11C and is perpendicular to the first main surface 11A, the thickness of the first covering electrode 71 is the maximum on the first main surface 11A side with respect to the geometric center C. Specifically, when the first end surface 11C is viewed in the second negative direction Y2, the geometric center C of the first end surface 11C is located in the fifth layer L5. The first covering electrode 71 intersects with the second virtual line VL2 only in the first layer L1. As described above, the first layer L1 is located on the first positive direction X1 side with respect to the fifth layer L5. Therefore, on the second virtual line VL2, the position where the thickness of the first covering electrode 71 is the maximum is shifted toward the first main surface 11A side with respect to the geometric center C of the first end surface 11C. Specifically, on the second virtual line VL2, the thickness of the first covering electrode 71 is the maximum in the first layer L1 on the first main surface 11A side with respect to the geometric center C.

On the other hand, the thickness of the first covering electrode 71 is the minimum at the geometric center C in a range from the geometric center C on the second virtual line VL2 to a position where the thickness of the first covering electrode 71 is the maximum. Specifically, on the second virtual line VL2, the first covering electrode 71 exists only in the first layer L1. Therefore, on the second virtual line VL2, the first covering electrode 71 does not exist in the range from the second layer L2 to the fifth layer L5. That is, the thickness of the first covering electrode 71 is 0 at the geometric center C. Therefore, in the range from the first layer L1 to the fifth layer L5 on the second virtual line VL2, the thickness of the first covering electrode 71 is the minimum in the fifth layer L5 where the geometric center C is located. The position where the thickness of the first covering electrode 71 is the minimum also means that the thickness of the first covering electrode 71 is 0. That is, it also means that the first covering electrode 71 at the geometric center C of the first end surface 11C is absent.

On the first end surface 11C, the dimension of the first covering electrode 71 in the direction perpendicular to the bottom surface 11E is defined as the height of the first covering electrode 71. That is, on the first end surface 11C, the dimension of the first covering electrode 71 in the direction along the third axis Z is the height of the first covering electrode 71.

The position where the height of the first covering electrode 71 is the maximum is shifted toward the first main surface 11A side with respect to the geometric center C of the first end surface 11C. Specifically, the first covering electrode 71 extends in the third positive direction Z1 in the first layer L1 as compared with the second layer L2 to the ninth layer L9. The upper end of the first covering electrode 71 in the first layer L1 is located on the top surface 11F side with respect to the second virtual line VL2. In the range of the second layer L2 to the ninth layer L9, the upper end of the first covering electrode 71 is located on the bottom surface 11E side with respect to the second virtual line VL2. In the range of the second layer L2 to the ninth layer L9, the height of the first covering electrode 71 is constant. When the height is constant, a variation of about 10% is allowed.

As illustrated in FIG. 2, the first wiring portion 31 extends parallel to the first main surface 11A from the first end of the inductor wiring 30. Among the plurality of wiring portions, a wiring portion extending parallel to the first main surface 11A from the first end of the inductor wiring 30 is defined as a first end wiring portion. In the present embodiment, the first wiring portion 31 is the first end wiring portion. At this time, the thickness of the first covering electrode 71 on the second virtual line VL2 is the maximum in the range of the first layer L1 where the first wiring portion 31 exists in the direction along the first axis X.

As illustrated in FIG. 1, the second covering electrode 72 covers a surface of the second buried electrode 50 exposed to the outside from the element body 11. Therefore, the second covering electrode 72 is electrically connected to the second end of the inductor wiring 30. The second covering electrode 72 covers the second end surface 11D at a part. Although not illustrated, the second covering electrode 72 has a two-layer structure of nickel plating and tin plating. In FIGS. 2 and 3, illustration of the second covering electrode 72 is omitted.

On a virtual line that passes through the geometric center of the second end surface 11D and is perpendicular to the second main surface 11B, the thickness of the second covering electrode 72 is the maximum on the second main surface 11B side with respect to the geometric center of the second end surface 11D. Specifically, when the second end surface 11D is viewed in the second positive direction Y1, the geometric center of the second end surface 11D is located on the fifth layer L5. The second covering electrode 72 intersects with the virtual line only in the ninth layer L9. As described above, the ninth layer L9 is located on the first negative direction X2 side with respect to the fifth layer L5. Therefore, on the virtual line, the thickness of the second covering electrode 72 is the maximum in the ninth layer L9 on the second main surface 11B side with respect to the geometric center of the second end surface 11D. Therefore, on the virtual line, the position where the thickness of the second covering electrode 72 is the maximum is shifted toward the second main surface 11B side with respect to the geometric center of the second end surface 11D. Specifically, on the virtual line, the thickness of the second covering electrode 72 is the maximum in the ninth layer L9 on the side opposite to the first main surface 11A with respect to the geometric center of the second end surface 11D.

On the other hand, in the range from the geometric center of the second end surface 11D on the virtual line to the position where the thickness of the second covering electrode 72 is the maximum, the thickness of the second covering electrode 72 is the minimum at the geometric center of the second end surface 11D. Specifically, only the ninth layer L9 exists in the second covering electrode 72 on the virtual line. Therefore, on the virtual line, the second covering electrode 72 does not exist in the range from the fifth layer L5 to the eighth layer L8. That is, the thickness of the second covering electrode 72 is 0 at the geometric center of the second end surface 11D. Therefore, in the range from the fifth layer L5 to the ninth layer L9 on the virtual line, the thickness of the second covering electrode 72 is the minimum in the fifth layer L5 where the geometric center of the second end surface 11D is located.

The position where the height of the second covering electrode 72 is the maximum is shifted toward the second main surface 11B side with respect to the geometric center of the second end surface 11D. Specifically, the second covering electrode 72 extends in the third positive direction Z1 in the ninth layer L9 as compared with the first layer L1 to the eighth layer L8. The upper end of the second covering electrode 72 in the ninth layer L9 is located on the top surface 11F side with respect to a virtual line that passes through the geometric center of the second end surface 11D and is perpendicular to the second main surface 11B. In the range of the first layer L1 to the eighth layer L8, the upper end of the second covering electrode 72 is located on the bottom surface 11E side with respect to the virtual line. In the range of the first layer L1 to the eighth layer L8, the height of the second covering electrode 72 is constant.

The fifth wiring portion 39 extends parallel to the first main surface 11A from the second end of the inductor wiring 30. Among the plurality of wiring portions, a wiring portion extending parallel to the second main surface 11B from the second end of the inductor wiring is defined as a second end wiring portion. In the present embodiment, the fifth wiring portion 39 is the second end wiring portion. At this time, the thickness of the second covering electrode 72 on a virtual line that passes through the geometric center of the second end surface 11D and is perpendicular to the second main surface 11B is the maximum in the range of the ninth layer L9 where the fifth wiring portion 39 exists in the direction along the first axis X.

(Method for Manufacturing Inductor Component)

Next, a method for manufacturing the inductor component 10 will be described.

As illustrated in FIG. 6, the method for manufacturing the inductor component 10 includes a laminate forming step S100, a firing step S200, and a plating step S300.

First, the laminate forming step S100 is performed. The laminate forming step S100 is a step of forming a laminate in a state before sintering of the element body 11. In the laminate forming step S100, the first covering insulating layer 61, the first layer L1 to the ninth layer L9, and the second covering insulating layer 62 are laminated in this order to form a laminate. Strictly speaking, the first covering insulating layer 61, the second covering insulating layer 62, and the first layer L1 to the ninth layer L9 in the laminate forming step S100 are layers before sintering, and may be different from the respective layers in the inductor component 10, but the same names are used for simplification of description. In this respect, strictly speaking, the inductor wiring 30, the first buried electrode 40, and the second buried electrode 50 are also in a state before sintering, and may be different from the respective members in the inductor component 10, but the same names are used for simplification of description.

Specifically, the laminate forming step S100 includes a first covering insulating layer applying step S10, a first layer applying step S11 to a ninth layer applying step S19, and a second covering insulating layer applying step S20. In the laminate forming step S100, the respective steps are performed in this order.

In the first covering insulating layer applying step S10, screen printing is performed using an insulating paste having an insulating property. Then, by repeating application by screen printing, an insulating paste layer corresponding to the first covering insulating layer 61 is formed. The insulating paste is, for example, paste having an insulating property containing borosilicate glass as a main component.

Next, in the first layer applying step S11, a layer corresponding to the first layer L1 is formed using a conductive paste containing metal powder in addition to the insulating paste. The metal powder is, for example, silver. Specifically, on the surface facing the first negative direction X2 of the insulating paste layer corresponding to the first covering insulating layer 61, conductor layers are formed by photolithography at portions corresponding to the first wiring portion 31, the first electrode portion 41, and the second electrode portion 51 using a conductive paste. In addition, an insulator layer is formed in a portion corresponding to the first insulating portion 21 by photolithography using an insulating paste.

Next, in the second layer applying step S12 to the ninth layer applying step S19, layers corresponding to the second layer L2 to the ninth layer L9 are formed using an insulating paste and a conductive paste, similarly to the first layer applying step S11. Thereby, a pattern of the conductive paste extending spirally inside the insulating paste is formed. In addition, a first conductive portion of the conductive paste which is connected to a first end of the pattern of the conductive paste and exposed from the insulating paste is formed. Further, a second conductive portion of the conductive paste which is connected to a second end of the pattern of the conductive paste and exposed from the insulating paste is formed.

Then, screen printing is performed using an insulating paste. Then, by repeating application by screen printing, a layer corresponding to the second covering insulating layer 62 is formed. Thereafter, the layers are cut into a desired size to form a laminate in a state before sintering of the element body 11.

In this way, in the laminate forming step S100, a rectangular parallelepiped laminate including the pattern of the conductive paste extending spirally inside the insulating paste, the first conductive portion, and the second conductive portion is formed.

Next, the firing step S200 is performed. The firing step S200 is a step of forming the element body 11 by firing the laminate. Specifically, the laminate is heated at a predetermined temperature to fire the laminate. As a result, the respective pastes are fired to form the insulating paste into the insulating portion 20, the pattern of the inductor wiring 30 into the inductor wiring 30, the first conductive portion into the first buried electrode 40, and the second conductive portion into the second buried electrode 50. That is, the first bottom surface electrode portion 40A and the first end surface electrode portion 40B in the first buried electrode 40 are formed. In addition, the second bottom surface electrode portion 50A and the second end surface electrode portion 50B in the second buried electrode 50 are formed. As a result, the element body 11 is formed.

Next, the plating step S300 is performed. The element body 11 is placed in a plating solution to perform electroplating. As a result, the first covering electrode 71 is formed on the surface of the element body 11 exposed to the outside of the first buried electrode 40. In addition, the second covering electrode 72 is formed on the surface of the element body 11 exposed to the outside of the second buried electrode 50.

In the electroplating, the first covering electrode 71 is formed only on the surface exposed to the outside of the first buried electrode 40. Therefore, as illustrated in FIG. 4, the first covering electrode 71 is not formed on the geometric center C of the first end surface 11C. On the other hand, the first covering electrode 71 is formed in the range of the first layer L1 on the first end surface 11C. Therefore, the thickness of the first covering electrode 71 is 0 on the geometric center C and is the maximum in the range of the first layer L1. That is, on the second virtual line VL2, the position where the thickness of the first covering electrode 71 is the maximum is shifted toward the first main surface 11A side with respect to the geometric center C. Note that the first covering electrode 71 is formed only on the surface exposed to the outside of the first buried electrode 40, but may be formed around the surface of the first buried electrode 40 exposed to the outside of the element body 11 due to some plating extension, an influence of an external force during measurement or packaging, or the like.

### Effects of First Embodiment

The inductor component 10 in the first embodiment has the following effects. Hereinafter, the effects of the first covering electrode 71 will be described as a representative, but the same effects are also obtained for the second covering electrode 72.
(1-1) For example, as other electronic components disposed so as to be adjacent to the first end surface 11C of the inductor component 10, one in which an electrode is plated on the entire end surface of a rectangular parallelepiped element body can be mentioned. In such an electronic component, the thickness of the electrode is large at the center of the end surface. That is, in this type of electronic component, the center of the end surface of the element body is bulged. In addition, under the current situation where the outer diameter size of the electronic components is substantially standardized, the land patterns on the substrate on which the electronic components are arranged are aligned in order to achieve high-density mounting. That is, when viewed from a direction perpendicular to the main surface of the substrate, the geometric center C of the first end surface 11C of the inductor component 10 and the geometric center of the end surface of another adjacent electronic component are often aligned in the same straight line and adjacent to each other.

According to the inductor component 10 in the first embodiment, the position where the thickness of the first covering electrode 71 is the maximum is shifted toward the first main surface 11A side with respect to the geometric center C of the first end surface 11C. Here, it is assumed that the inductor component 10 and the other electronic component are arranged at adjacent positions of the aligned land patterns on the substrate. Even in this case, the position where the thickness of the first covering electrode 71 of the inductor component 10 is the maximum is deviated from the position where the thickness of the electrode of the other electronic component is the maximum. Therefore, the electrodes of both components hardly interfere with each other. Therefore, it is possible to contribute to densification of components on the substrate.
(1-2) According to the inductor component 10 in the first embodiment, the position where the height of the first covering electrode 71 is the maximum is shifted toward the first main surface 11A side with respect to the geometric center C of the first end surface 11C. It is assumed that the position of the upper end of the first covering electrode 71 is located on the top surface 11F side with respect to the second virtual line VL2 in the entire range in the direction along the first axis X. As compared with this case, the range in which the first covering electrode 71 covers the inductor wiring 30 is smaller at the center in the direction along the first axis X on the first end surface 11C. Therefore, the stray capacitance generated when the current flows through the inductor wiring 30 can be reduced.
(1-3) According to the inductor component 10 in the first embodiment, the thickness of the first covering electrode 71 on the second virtual line VL2 is the maximum in the range of the first layer L1 where the first wiring portion 31 extending parallel to the first main surface 11A from the first end of the inductor wiring 30 exists. That is, in the direction along the first axis X, the thickness of the first covering electrode 71 is the maximum at a position away from the geometric center C. Therefore, interference of the first covering electrode 71 with other electronic components can be more suitably suppressed.

### Second Embodiment

Hereinafter, a second embodiment will be described with reference to the drawings. An inductor component 110 of the second embodiment is different from the inductor component 10 of the first embodiment in the shapes of the first covering electrode 71 and the second covering electrode 72. Hereinafter, differences from the inductor component 10 in the first embodiment will be mainly described, and the description of the same points will be simplified or omitted. Regarding the second covering electrode 72, the description of the same points as those of the first covering electrode 71 is simplified or omitted.

(End Surface Electrode Portion and Covering Electrode)

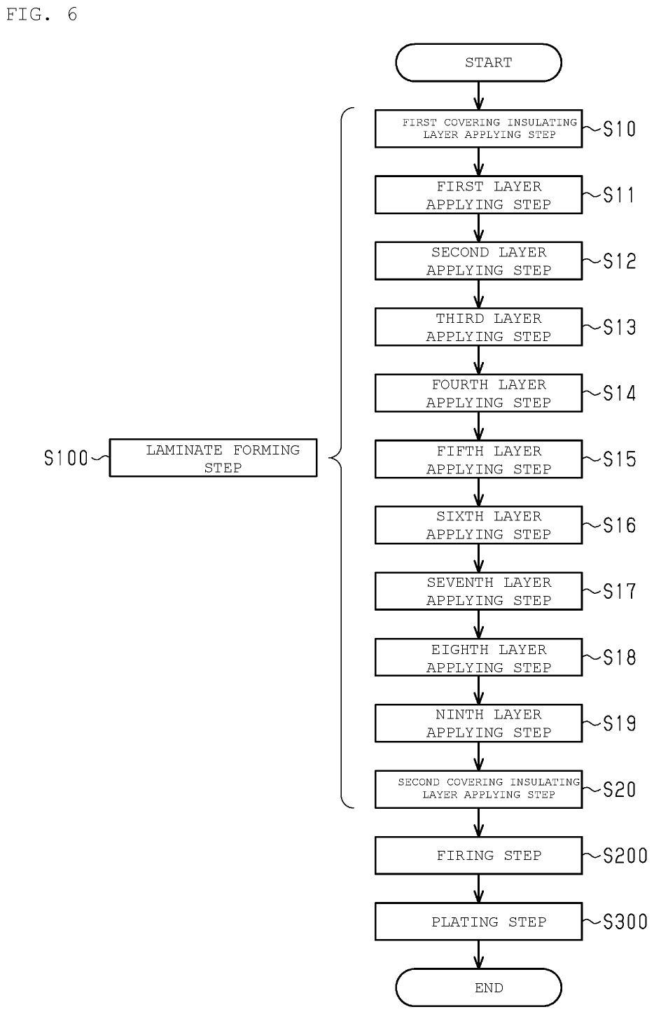

As illustrated in FIG. 7, shapes of a second electrode portion 51 to a seventeenth electrode portion 49 of the inductor component 110 are different from those of the first embodiment. Specifically, the third electrode portion 42 to the seventeenth electrode portion 49 have an L shape having the same size and the same shape as the first electrode portion 41. In addition, the second electrode portion 51 to the sixteenth electrode portion 58 have an L shape having the same size and the same shape as the eighteenth electrode portion 59. Therefore, when the first end surface 11C is viewed in the second negative direction Y2, the first end surface electrode portion 40B has a quadrangular shape. Similarly, when the second end surface 11D is viewed in the second positive direction Y1, the second end surface electrode portion 50B has a quadrangular shape.

The first buried electrode 40 is a sintered body made of metal and glass. The electric resistance value at the geometric center C of the first end surface 11C in the first end surface electrode portion 40B is larger than the electric resistance value at the position where the thickness of the first covering electrode 71 is the maximum. In the present embodiment, the electric resistance value at the same position as the geometric center C in the direction along the first axis X in the first end surface electrode portion 40B is larger than the electric resistance value at the position closest to the first main surface 11A in the first end surface electrode portion 40B. Specifically, in the first end surface electrode portion 40B, the density of metal at the geometric center C of the first end surface 11C is coarser than the density of metal at the position where the thickness of the first covering electrode 71 is the maximum in the second virtual line VL2. In the present embodiment, the density of metal at the same position as the geometric center C in the direction along the first axis X in the first end surface electrode portion 40B is coarser than the density of metal at the position closest to the first main surface 11A in the first end surface electrode portion 40B. In the present embodiment, in the first buried electrode 40, the first electrode portion 41 and the seventeenth electrode portion 49 have a denser metal structure than the third electrode portion 42 to the fifteenth electrode portion 48.

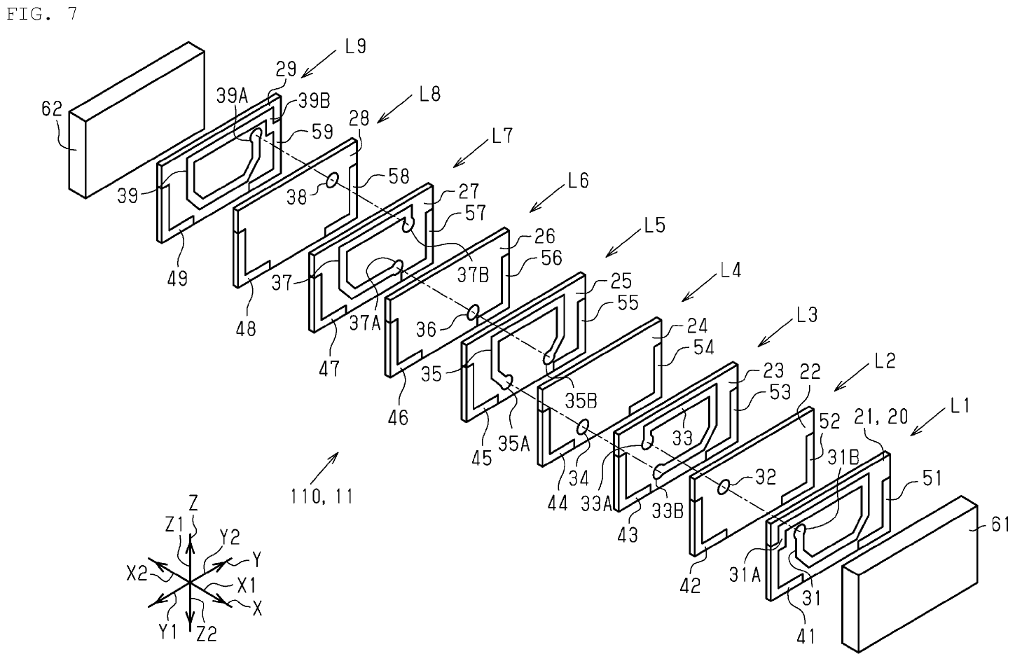

As illustrated in FIG. 8, the first covering electrode 71 covering the surface of the first end surface electrode portion 40B also has a quadrangular shape when the inductor component 110 is viewed in the second negative direction Y2. The height of the first covering electrode 71 is the same in the entire range in the direction along the first axis X. In the direction along the first axis X, the height of the first covering electrode 71 may be slightly higher at the geometric center C than at other positions, or may be slightly lower at the first layer L1 and the ninth layer L9 than at other positions.

As illustrated in FIG. 9, the thickness of the first covering electrode 71 on the second virtual line VL2 is not the maximum at the geometric center C. Specifically, the thickness of the first covering electrode 71 on the second virtual line VL2 is the maximum in the first layer L1 and the ninth layer L9. In the present embodiment, the first covering electrode 71 also exists on the geometric center C of the first end surface 11C. Therefore, the thickness of the first covering electrode 71 at the geometric center C is not 0. The thickness of the first covering electrode 71 from the second layer L2 to the eighth layer L8 is the minimum in the range of the first layer L1 to the ninth layer L9. That is, the thickness of the first covering electrode 71 at the geometric center C is the minimum in the range from the geometric center C to the first layer L1.

Similarly to the first buried electrode 40, the second buried electrode 50 is a sintered body made of metal and glass. Similarly to the first end surface electrode portion 40B, the electric resistance value at the geometric center of the second end surface 11D in the second end surface electrode portion 50B is larger than the electric resistance value at the position where the thickness of the second covering electrode 72 is the maximum. In the present embodiment, the electric resistance value at the same position as the geometric center of the second end surface 11D in the direction along the first axis X in the second end surface electrode portion 50B is larger than the electric resistance value at the position closest to the second main surface 11B in the second end surface electrode portion 50B. Specifically, in the second end surface electrode portion 50B, the density of metal at the geometric center of the second end surface 11D is coarser than the density of metal at a position where the thickness of the first covering electrode 71 is the maximum on a virtual line that passes through the geometric center of the second end surface 11D and is perpendicular to the second main surface 11B. In the present embodiment, the density of metal at the same position as the geometric center of the second end surface 11D in the direction along the first axis X in the second end surface electrode portion 50B is sparser than the density of metal at a position closest to the second main surface 11B in the second end surface electrode portion 50B. In the present embodiment, in the second buried electrode 50, the second electrode portion 51 and the eighteenth electrode portion 59 have a denser metal structure than the fourth electrode portion 52 to the sixteenth electrode portion 58.

Although not illustrated, similarly to the first covering electrode 71, the second covering electrode 72 covering the surface of the second end surface electrode portion 50B also has a quadrangular shape when the inductor component 110 is viewed in the second positive direction Y1. The height of the second covering electrode 72 is the same in the entire range in the direction along the first axis X.

The thickness of the second covering electrode 72 on a virtual line that passes through the geometric center of the second end surface 11D and is parallel to the first axis X is the maximum in the first layer L1 and the ninth layer L9. In the present embodiment, the second covering electrode 72 also exists on the geometric center of the second end surface 11D. Therefore, the thickness of the second covering electrode 72 at the geometric center of the second end surface 11D is not 0. The thickness of the second covering electrode 72 from the second layer L2 to the eighth layer L8 is the minimum in the range of the first layer L1 to the ninth layer L9. That is, the thickness of the second covering electrode 72 at the geometric center of the second end surface 11D is the minimum in the range from the geometric center of the second end surface 11D to the ninth layer L9.

(Method for Manufacturing Inductor Component)

Next, a method for manufacturing the inductor component 110 will be described. As compared with the method for manufacturing the inductor component 10 of the first embodiment, the material of the conductive paste used in the second embodiment is different in a part.

Specifically, the conductive paste used in the second layer applying step S12 to the eighth layer applying step S18 in the laminate forming step S100 contains a sintering inhibitor. The sintering inhibitor is a glass powder. The conductive paste used in the first layer applying step S11 and the ninth layer applying step S19 does not contain a sintering inhibitor.

In the firing step S200, the conductive paste containing a sintering inhibitor is less likely to be sintered than the conductive paste not containing a sintering inhibitor. When the paste containing the metal powder is sintered, the grains change so as to approach each other, and the metal structure that has become the sintered body is less likely to be densified at a position that is less likely to be sintered. That is, the density of metal in the second layer L2 to the eighth layer L8 of the first buried electrode 40 is sparser than the density of metal in the first layer L1 and the ninth layer L9 of the first buried electrode 40.

In the plating step S300, electroplating is performed on the surface of the first buried electrode 40. In electroplating, the amount of plating is affected by the electric resistance value of the surface of the first buried electrode 40 to be plated. Specifically, when more current flows per unit time, more plating is performed. On the other hand, when less current flows per unit time, less plating is performed. Therefore, since the deposition rate of plating changes depending on the magnitude of the electric resistance value, the amount of plating changes with the same plating time. In the present embodiment, the surfaces of the second layer L2 to the eighth layer L8 of the first buried electrode 40 are sparser in metal density than the surfaces of the first layer L1 and the ninth layer L9. When the density of the metal is sparse, the number of contact points between the metals is reduced, so that the electric resistance value is further increased. Therefore, the surfaces of the second layer L2 to the eighth layer L8 of the first buried electrode 40 are plated more than the surfaces of the first layer L1 and the ninth layer L9. As a result, the thickness of the first covering electrode 71 is smaller in the second layer L2 to the eighth layer L8 than in the first layer L1 and the ninth layer L9.

### Effects of Second Embodiment

According to the second embodiment, in addition to the effects of (1-1) and (1-3) of the first embodiment, the following effects are obtained. Hereinafter, the effects of the first covering electrode 71 will be described as a representative, but the same effects are also obtained for the second covering electrode 72.
(2-1) According to the second embodiment, the electric resistance value at the geometric center C of the first end surface 11C in the first end surface electrode portion 40B is larger than the electric resistance value at the position where the thickness of the first covering electrode 71 is the maximum. Therefore, in the plating step S300, electroplating is hardly performed at the geometric center C. Therefore, it is easy to form the first covering electrode 71 having a different thickness for each position on the first end surface electrode portion 40B.
(2-2) According to the second embodiment, when electroplating is performed on the first end surface electrode portion 40B, it is difficult for current to flow at the center of the first end surface electrode portion 40B in the direction along the first axis X, reflecting the fact that the density of metal is sparse. Therefore, in a sintered body made of the same metal and glass, the electric resistance value can be changed by the difference in the density of the metal.

### Other Embodiments

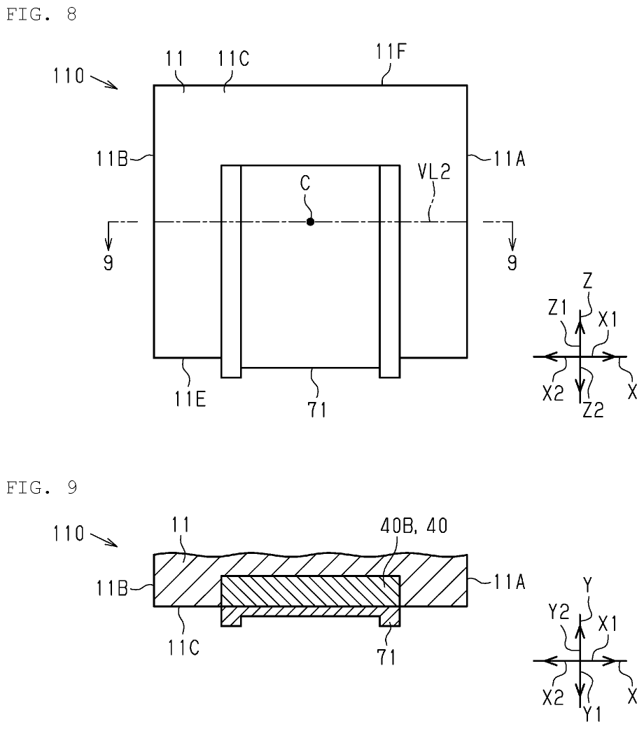

The above embodiments can be modified and implemented as follows. The above embodiments and the following modifications can be implemented in combination within a range not technically contradictory. The common point between the first covering electrode 71 and the second covering electrode 72 will be described as a representative of the first covering electrode 71, and the description of the second covering electrode 72 will be omitted.
In the first embodiment, the thicknesses of the first layer L1 to the ninth layer L9 are substantially the same, but may be different from each other. That is, the thicknesses of the first layer L1 to the ninth layer L9, that is, the dimensions in the direction along the first axis X are not necessarily the same. All the thicknesses may be different from each other, or the thicknesses of some layers may be different from the thicknesses of other layers.
The element body 11 may be a rectangular parallelepiped that is long in the direction along the first axis X or a rectangular parallelepiped that is long in the direction along the third axis Z. Further, the element body 11 may be a rectangular parallelepiped having the same dimension in the direction along the first axis X, the same dimension in the direction along the second axis Y, and the same dimension in the direction along the third axis Z. For example, with respect to the dimension in the direction along each axis of the element body 11, the dimension in the direction along the first axis X may be equal to the dimension in the direction along the third axis Z, and the dimension in the direction along the second axis Y may be larger than the dimension in the direction along the first axis X. For example, with respect to the dimension in the direction along each axis of the element body 11, the dimension in the direction along the second axis Y may be larger than the dimension in the direction along the third axis Z, and the dimension in the direction along the third axis Z may be larger than the dimension in the direction along the first axis X. For example, the dimension in the direction along the second axis Y may be larger than the dimension in the direction along the first axis X, and the dimension in the direction along the first axis X may be larger than the dimension in the direction along the third axis Z.
In addition, the laminating direction of each layer of the element body 11 is not limited to the example of each of the above embodiments. Each layer of the element body 11 may be laminated along the second axis Y or may be laminated along the third axis Z.
The material of the insulating portion 20 is not limited to the example of the above embodiment, and may be an insulator. For example, the material of the insulating portion 20 may be a magnetic insulator. In addition, a part of the insulating portion 20 may be a nonmagnetic or magnetic insulator different from other portions.
The first covering insulating layer 61 may have a configuration in which a plurality of insulating layers are laminated. When the first covering insulating layer 61 includes a plurality of insulating layers, some of the insulating layers may be colored. In this respect, the same applies to the second covering insulating layer 62.
The configuration of the inductor wiring 30 is not limited to the example of the above embodiment. It is sufficient to extend inside the element body 11, and the shape, length, and the like may be appropriately changed according to necessary characteristics. In each embodiment, the inductor wiring 30 is wound around an axis parallel to the bottom surface 11E, but the inductor wiring 30 may be wound around an axis perpendicular to the bottom surface 11E. Alternatively, the inductor wiring 30 may be wound around an axis parallel to the bottom surface 11E and perpendicular to the first end surface 11C.
The number of turns of each layer of the inductor wiring 30 is not limited to less than one turn. The inductor wiring 30 may be wound one or more turns in each layer. That is, the inductor wiring 30 may have a spiral structure.
In the first embodiment, the wiring width of the first wiring portion 31 may be substantially constant including the second end portion 31B. In this respect, the same applies to the wiring widths of the other wiring portions.
The position of the end portion of each wiring portion in the inductor wiring 30 is not limited to the position of each of the above embodiments. The position of the end portion of each wiring portion in the inductor wiring 30 may be appropriately changed.
In the first embodiment, the L-shaped first tip of the first electrode portion 41 on the third positive direction Z1 side may be located on the third positive direction Z1 side with respect to the center of the first layer L1. In this respect, the same applies to the eighteenth electrode portion 59.
In the first embodiment, the fifth electrode portion 43 may have a dimension different from that of the third electrode portion 42. In this respect, the same applies to other electrode portions.
The shape of the first covering electrode 71 is not limited to the example of the above embodiment. When the inductor component 10 is viewed in the second negative direction Y2, the shape of the first covering electrode 71 may be changed in accordance with the exposure range of the first end surface electrode portion 40B of the first buried electrode 40. For example, in the first embodiment, the first covering electrode 71 in the first layer L1 protrudes in a rectangular parallelepiped shape, but may protrude in a curved surface shape. Further, for example, the thickness and height may be changed from the first layer L1 to the second layer L2 and the third layer L3 in a gently curved shape or a tapered shape.
An inductor component 210 of the modification illustrated in FIG. 10 differs from the inductor component 10 of the first embodiment in the shape of the first covering electrode 71 when the inductor component 110 is viewed in the second negative direction Y2. In the first covering electrode 71 of the inductor component 210, the height of the first covering electrode 71 in the fifth layer L5 is the minimum. The upper end of the first covering electrode 71 in the fifth layer L5 is located on the bottom surface 11E side with respect to the geometric center C. The height of the first covering electrode 71 in the fourth layer L4 and the sixth layer L6 is larger than the height of the first covering electrode 71 in the fifth layer L5. Further, the height of the first covering electrode 71 in the third layer L3 and the seventh layer L7 is larger than the height of the first covering electrode 71 in the fourth layer L4 and the sixth layer L6. The height of the first covering electrode 71 in the second layer L2, the eighth layer L8, and the ninth layer L9 is larger than the height of the first covering electrode 71 in the third layer L3 and the seventh layer L7. In addition, the height of the first covering electrode 71 in the first layer L1 is the maximum in the first layer L1 to the ninth layer L9. In this manner, the height of the first covering electrode 71 may gradually change from the first layer L1 toward the fifth layer L5. In this modification, the first covering electrode 71 does not exist on the geometric center C of the first end surface 11C. Therefore, the thickness of the first covering electrode 71 on the second virtual line VL2 is the minimum on the geometric center C.

When the position where the thickness of the first covering electrode 71 is the maximum is shifted toward the first main surface 11A side with respect to the geometric center C of the first end surface 11C on the second virtual line, the thickness of the first covering electrode 71 may not be minimum on the geometric center C. In addition, when the position where the thickness of the first covering electrode 71 is the maximum is shifted toward the first main surface 11A side with respect to the geometric center C of the first end surface 11C, the thickness of the first covering electrode 71 may not be the maximum in the first layer L1 or the ninth layer L9.

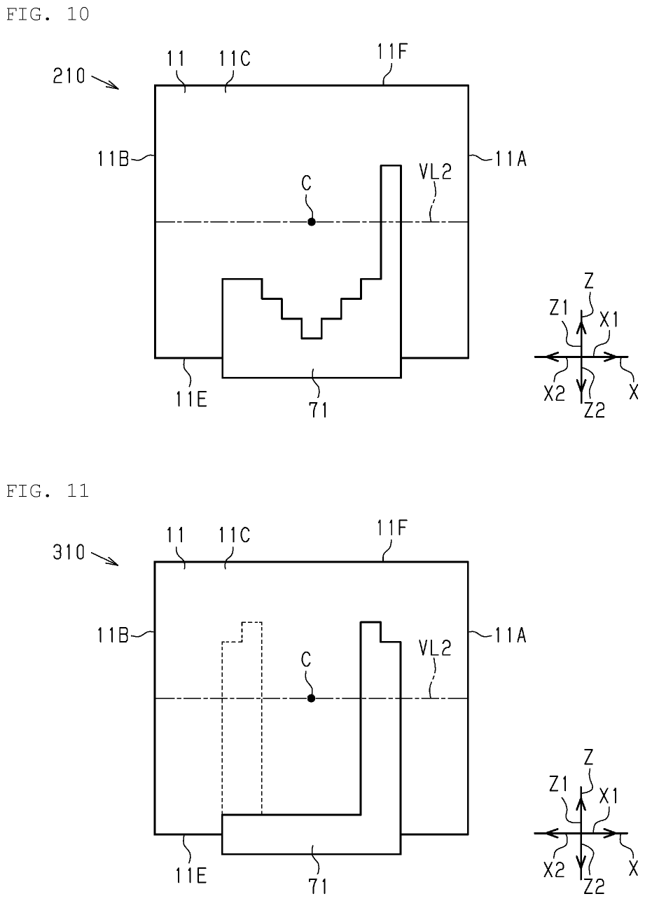

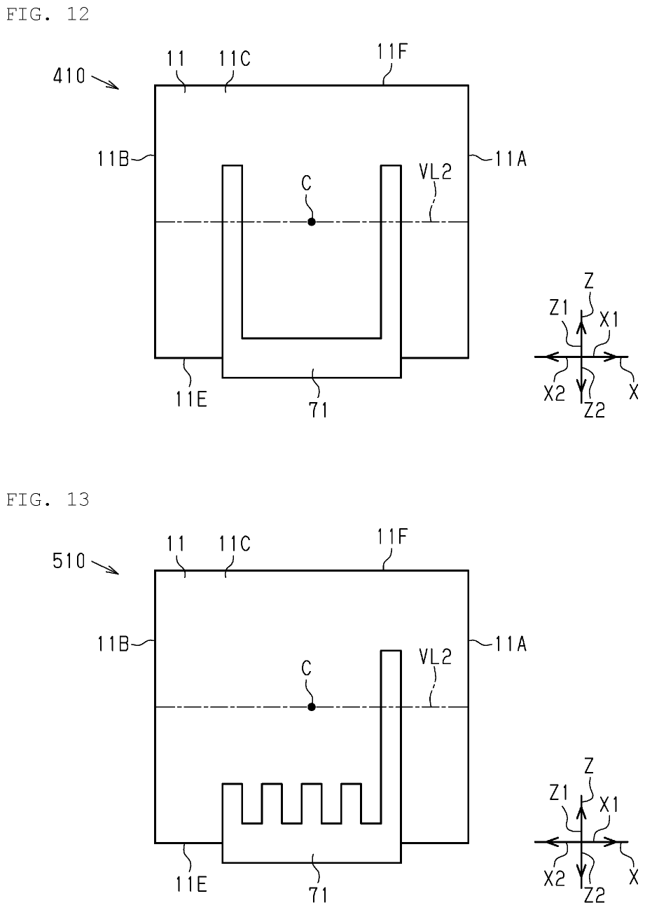

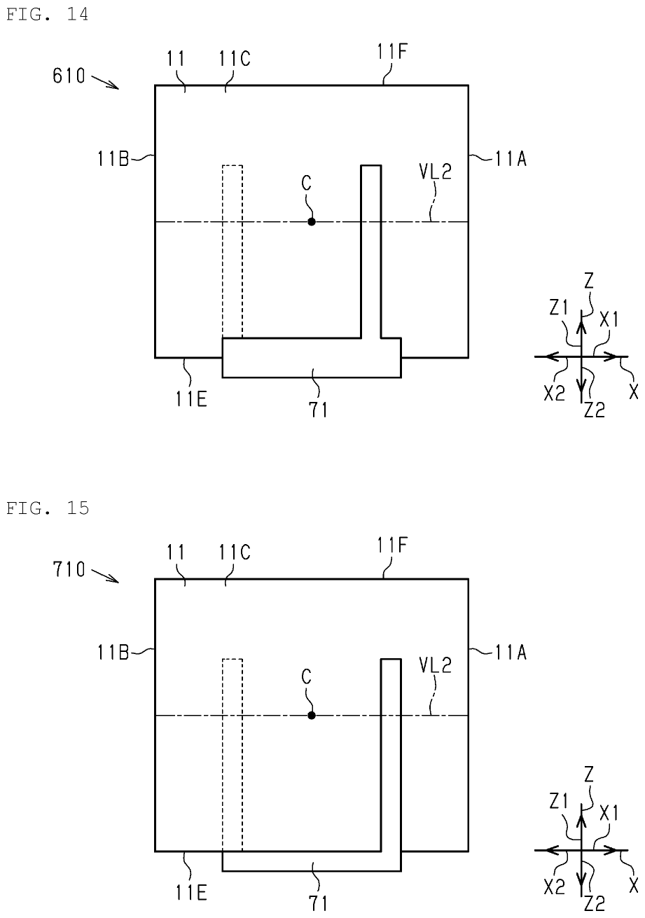

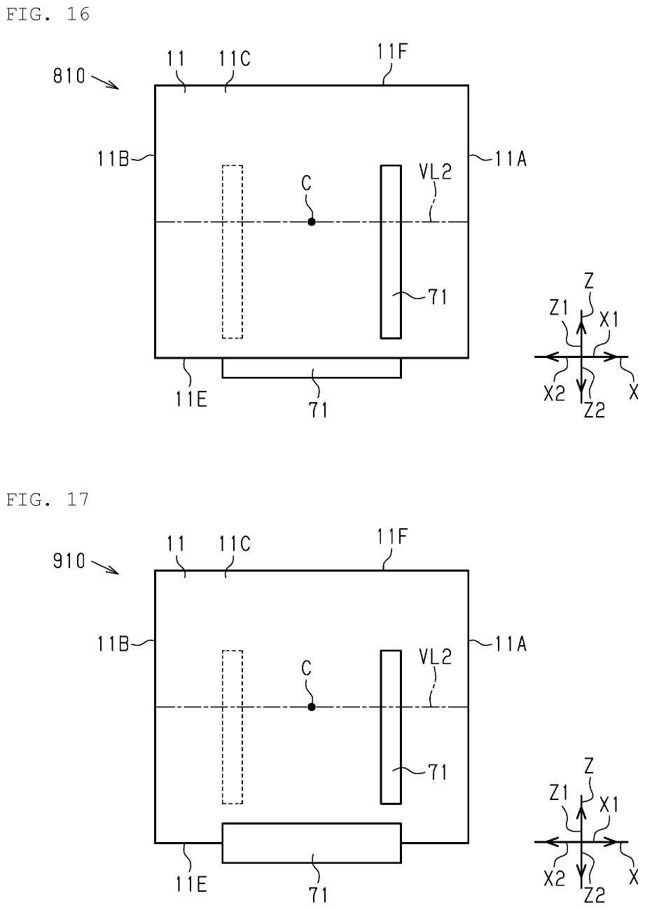

The first covering electrode 71 may be smoothly connected between layers. That is, when the inductor component 110 is viewed in the second negative direction Y2, the outer edge of the first covering electrode 71 may have no corner and may be curved. Further, the surface of the first covering electrode 71 covering the first end surface 11C may be a curved surface.
An inductor component 310 of the modification illustrated in FIG. 11 is different from the inductor component 10 of the first embodiment in the height of the first covering electrode 71 in the second layer L2. Specifically, the height of the first covering electrode 71 in the second layer L2 is larger than the height of the first covering electrode 71 in the first layer L1. The upper end of the first covering electrode 71 in the second layer L2 is located on the top surface 11F side with respect to the second virtual line VL2. Even in this case, in the direction along the first axis X, the height of the first covering electrode 71 is the maximum on the first main surface 11A side with respect to the geometric center C.
An inductor component 410 of the modification illustrated in FIG. 12 is different from the inductor component 10 of the first embodiment in the height of the first covering electrode 71 in the ninth layer L9. Specifically, the height of the first covering electrode 71 in the ninth layer L9 is equal to the height of the first covering electrode 71 in the first layer L1. Therefore, in the direction along the first axis X, the height of the first covering electrode 71 is equal at positions where the distance from the geometric center C is the same between the range on the first positive direction X1 side from the geometric center C and the range on the first negative direction X2 side. In this case, when the inductor component 410 is mounted on the substrate, the stability in the direction along the first axis X is easily improved.
In an inductor component 510 of the modification illustrated in FIG. 13, the height of the first covering electrode 71 in the fifth layer L5 is not the minimum as compared with the inductor component 10 of the first embodiment. Specifically, in the inductor component 510, the heights of the first covering electrodes 71 in the third layer L3, the fifth layer L5, the seventh layer L7, and the ninth layer L9 are different from those of the inductor component 10 of the first embodiment. The height of the first covering electrode 71 in the third layer L3, the fifth layer L5, the seventh layer L7, and the ninth layer L9 of the inductor component 510 is larger than the height of the first covering electrode 71 in the second layer L2. The height of the first covering electrode 71 in the third layer L3, the fifth layer L5, the seventh layer L7, and the ninth layer L9 of the inductor component 510 is smaller than the height of the first covering electrode 71 in the first layer L1. Therefore, when the inductor component 510 is viewed in the second negative direction Y2, the first covering electrode 71 in the second layer L2 to the ninth layer L9 has a comb shape.
An inductor component 610 of the modification illustrated in FIG. 14 is different from the inductor component 10 of the first embodiment in the height of the first covering electrode 71 in the first layer L1 and the second layer L2. Specifically, the height of the first covering electrode 71 in the second layer L2 of the inductor component 610 is the maximum, and the height of the first covering electrode 71 in the first layer L1 is equal to the height of the first covering electrode 71 in the fifth layer L5. That is, in the inductor component 610, the thickness of the first covering electrode 71 on the second virtual line VL2 is the maximum outside the range of the first layer L1 where the first wiring portion 31 as the first end wiring portion exists.
An inductor component 710 of the modification illustrated in FIG. 15 is different from the inductor component 10 of the first embodiment in the range where the first covering electrode 71 exists. Specifically, the first covering electrode 71 in the inductor component 710 exists only in the first layer L1 on the first end surface 11C. That is, in the second layer L2 to the eighth layer L8, the first covering electrode 71 does not exist on the first end surface 11C. For example, when the first bottom surface electrode portion 40A and the first end surface electrode portion 40B exist only in the first layer L1, as described above, the first covering electrode 71 exists only in the first layer L1. In order to further reduce the stray capacitance on the first end surface 11C, it is preferable to reduce the range of the first covering electrode 71 existing on the first end surface 11C.
An inductor component 810 of the modification illustrated in FIG. 16 is different from the inductor component 710 of the modification in the existing range in the range in the direction along the third axis Z of the first covering electrode 71. Specifically, in the inductor component 810, a part including an end on the third negative direction Z2 side is omitted as compared with the inductor component 710. That is, the first covering electrode 71 is divided into a portion covering the first end surface electrode portion 40B and a portion covering the first bottom surface electrode portion 40A. Even in this case, the thickness of the first covering electrode 71 in the first layer L1 may be the maximum on the second virtual line VL2.
An inductor component 910 of the modification illustrated in FIG. 17 is different from the inductor component 10 of the first embodiment in the range where the first covering electrode 71 exists. Specifically, in the inductor component 910, a part of the first covering electrode 71 including the end on the third negative direction Z2 side in the range covering the first end surface electrode portion 40B is omitted as compared with the inductor component 10. Therefore, the first covering electrode 71 is divided into two portions on the first end surface 11C.
In the inductor component 110 of the second embodiment, the composition of the sintered body of the first end surface electrode portion 40B in the first layer L1 and the ninth layer L9 may be different from the composition of the sintered body of the first end surface electrode portion 40B in the second layer L2 to the eighth layer L8. For example, the material of the first end surface electrode portion 40B in the first layer L1 and the ninth layer L9 may be silver, and the material of the first end surface electrode portion 40B in the second layer L2 to the eighth layer L8 may be gold. In this case, the electric resistance value of gold is larger than the electric resistance value of silver. Therefore, by performing electroplating, it is possible to form the first covering electrode 71 having different thicknesses at different positions on the first end surface electrode portion 40B. For example, the combination of metals having different electric resistance values is not limited to gold and silver, and may be silver and copper, or copper and gold. For example, the difference in electric resistance value may be realized by varying the composition ratio of the alloy.
In the inductor component 110 of the second embodiment, the thickness of the first covering electrode 71 in the second layer L2 to the eighth layer L8 may be 0. That is, the thickness of the first covering electrode 71 may be 0 on the geometric center C of the first end surface 11C. That is, in the second layer L2 to the eighth layer L8, the first end surface electrode portion 40B may be exposed to the outside of the element body 11 without being covered with the first covering electrode 71. In this case, in plating step S300 in the method for manufacturing the inductor component 110 of the second embodiment, the surface of the first end surface electrode portion 40B in the second layer L2 to the eighth layer L8 may be covered with a cover having an insulating property and then electroplated. That is, plating may be performed by covering the geometric center C of the first end surface electrode portion 40B with the cover and exposing a portion of the first end surface electrode portion 40B on the first main surface 11A side with respect to the geometric center C on the second virtual line VL2 from the cover.
The first buried electrode 40 may have at least the first end surface electrode portion 40B. That is, the first bottom surface electrode portion 40A of the first buried electrode 40 may be omitted.
The first buried electrode 40 may be omitted. In this case, the first covering electrode 71 may be electrically connected to the first end of the inductor wiring 30.
The range in which the first covering electrode 71 covers the bottom surface 11E may be appropriately changed as long as it covers a part of the bottom surface 11E on the first virtual line VL1.
The shape of the second covering electrode 72 when the inductor component 10 is viewed in the second positive direction Y1 may be different from the shape of the first covering electrode 71 when the inductor component 10 is viewed in the second negative direction Y2.

The technical idea that can be grasped from the above embodiments and modifications will be described.
<1> An Inductor component including an element body having a rectangular parallelepiped shape having six outer surfaces; an inductor wiring extending inside the element body; a first covering electrode that covers a bottom surface, which is one of the outer surfaces, and is electrically connected to a first end of the inductor wiring; and a second covering electrode that covers the bottom surface and is electrically connected to a second end of the inductor wiring. When one of the six outer surfaces of the element body perpendicular to the bottom surface is defined as a main surface, and surfaces perpendicular to both the bottom surface and the main surface are defined as a first end surface and a second end surface, the first covering electrode and the second covering electrode cover a part of a first virtual line that passes through a geometric center of the bottom surface and is perpendicular to the first end surface, and the first covering electrode covers the first end surface, and the second covering electrode covers the second end surface. Also, when a distance from the first end surface to a surface of the first covering electrode in a direction perpendicular to the first end surface is defined as a thickness of the first covering electrode, a position where the thickness of the first covering electrode is maximum is shifted toward a main surface side with respect to a geometric center of the first end surface on a second virtual line that passes through the geometric center of the first end surface and is perpendicular to the main surface.
<2> The inductor component according to <1>, in which, when a dimension of the first covering electrode in a direction perpendicular to the bottom surface on the first end surface is defined as a height of the first covering electrode, a position where the height of the first covering electrode is maximum is shifted toward the main surface side with respect to the geometric center of the first end surface.
<3> The inductor component according to <1> or <2>, in which the inductor wiring includes a plurality of wiring portions arranged in a direction perpendicular to the main surface and a via connecting the wiring portions adjacent to each other in the direction perpendicular to the main surface. Also, when, among the plurality of wiring portions, the wiring portion extending parallel to the main surface from the first end is defined as a first end wiring portion, the thickness of the first covering electrode on the second virtual line is maximum in a range where the first end wiring portion exists in the direction perpendicular to the main surface.
<4> The inductor component according to any one of <1> to <3>, in which the element body includes a first buried electrode connected to the first end of the inductor wiring and in direct contact with the first covering electrode, and in which the first buried electrode includes an end surface electrode portion that is exposed to an outside of the element body at the first end surface and is covered with the first covering electrode.
<5> The inductor component according to <4>, in which an electric resistance value at the geometric center of the first end surface of the end surface electrode portion is larger than an electric resistance value at a position where the thickness of the first covering electrode is maximum.
<6> The inductor component according to <5>, in which the end surface electrode portion is a sintered body made of metal and glass, and in which a density of the metal at the geometric center of the first end surface in the end surface electrode portion is coarser than a density of the metal at a position where the thickness of the first covering electrode is maximum on the second virtual line.
<7> The inductor component according to <5>, in which the end surface electrode portion is a sintered body, and in which a composition of the sintered body at the geometric center of the first end surface in the end surface electrode portion is different from a composition of the sintered body at the position where the thickness of the first covering electrode is maximum on the second virtual line.
<8> The inductor component according to any one of <1> to <7>, in which the thickness of the first covering electrode is 0 on the geometric center of the first end surface.
<9> A method for manufacturing an inductor component, including a laminate forming step of forming, using a conductive paste containing an insulating paste having an insulating property and metal powder, a laminate having a rectangular parallelepiped shape, the laminate including a pattern of the conductive paste extending spirally inside the insulating paste, a first conductive portion of the conductive paste connected to a first end of the pattern and exposed from the insulating paste, and a second conductive portion of the conductive paste connected to a second end of the pattern and exposed from the insulating paste. The method further includes a firing step of firing the laminate to form an element body including a first buried electrode in which the first conductive portion is sintered and a second buried electrode in which the second conductive portion is sintered; and a plating step of plating surfaces of the first buried electrode and the second buried electrode exposed to a surface of the element body to form a first covering electrode covering the surface of the first buried electrode and a second covering electrode covering the surface of the second buried electrode. When one of six outer surfaces of the element body is defined as a bottom surface, one of surfaces perpendicular to the bottom surface is defined as a main surface, and surfaces perpendicular to both the bottom surface and the main surface are defined as a first end surface and a second end surface, the first buried electrode and the second buried electrode are exposed to an outside of the element body on the bottom surface, and the first buried electrode includes an end surface electrode portion exposed to the outside of the element body at the first end surface. Also, in the plating step, a geometric center of the first end surface is covered with a cover having an insulating property, and plating is performed by exposing a portion of the end surface electrode portion on the main surface side with respect to the geometric center from the cover on a virtual line that passes through the geometric center of the first end surface and is perpendicular to the main surface.

What is claimed is:

1. An inductor component comprising:
an element body having a rectangular parallelepiped shape having six outer surfaces;
an inductor wiring extending inside the element body;
a first covering electrode that covers a bottom surface, which is one of the outer surfaces, and is electrically connected to a first end of the inductor wiring; and
a second covering electrode that covers the bottom surface and is electrically connected to a second end of the inductor wiring,
when one of the six outer surfaces of the element body perpendicular to the bottom surface is defined as a main surface, and surfaces perpendicular to both the bottom surface and the main surface are defined as a first end surface and a second end surface,
the first covering electrode and the second covering electrode cover a part of a first virtual line that passes through a geometric center of the bottom surface and is perpendicular to the first end surface, and
the first covering electrode covers the first end surface, and the second covering electrode covers the second end surface, and
when a distance from the first end surface to a surface of the first covering electrode in a direction perpendicular to the first end surface is defined as a thickness of the first covering electrode,
a position where the thickness of the first covering electrode is maximum is shifted toward a main surface side with respect to a geometric center of the first end surface on a second virtual line that passes through the geometric center of the first end surface and is perpendicular to the main surface.

2. The inductor component according to claim 1, wherein
when a dimension of the first covering electrode in a direction perpendicular to the bottom surface on the first end surface is defined as a height of the first covering electrode,
a position where the height of the first covering electrode is maximum is shifted toward the main surface side with respect to the geometric center of the first end surface.

3. The inductor component according to claim 1, wherein
the inductor wiring includes a plurality of wiring portions arranged in a direction perpendicular to the main surface and a via connecting the wiring portions adjacent to each other in the direction perpendicular to the main surface, and
when, among the plurality of wiring portions, the wiring portion extending parallel to the main surface from the first end is defined as a first end wiring portion,
the thickness of the first covering electrode on the second virtual line is maximum in a range where the first end wiring portion exists in the direction perpendicular to the main surface.

4. The inductor component according to claim 1, wherein
the element body includes a first buried electrode connected to the first end of the inductor wiring and in direct contact with the first covering electrode, and
the first buried electrode includes an end surface electrode portion that is exposed to an outside of the element body at the first end surface and is covered with the first covering electrode.

5. The inductor component according to claim 4, wherein
an electric resistance value at the geometric center of the first end surface of the end surface electrode portion is larger than an electric resistance value at a position where the thickness of the first covering electrode is maximum.

6. The inductor component according to claim 5, wherein
the end surface electrode portion is a sintered body made of metal and glass, and
a density of the metal at the geometric center of the first end surface in the end surface electrode portion is coarser than a density of the metal at a position where the thickness of the first covering electrode is maximum on the second virtual line.

7. The inductor component according to claim 5, wherein
the end surface electrode portion is a sintered body, and
a composition of the sintered body at the geometric center of the first end surface in the end surface electrode portion is different from a composition of the sintered body at the position where the thickness of the first covering electrode is maximum on the second virtual line.

8. The inductor component according to claim 1, wherein
the thickness of the first covering electrode is 0 on the geometric center of the first end surface.

9. The inductor component according to claim 2, wherein
the inductor wiring includes a plurality of wiring portions arranged in a direction perpendicular to the main surface and a via connecting the wiring portions adjacent to each other in the direction perpendicular to the main surface, and
when, among the plurality of wiring portions, the wiring portion extending parallel to the main surface from the first end is defined as a first end wiring portion,
the thickness of the first covering electrode on the second virtual line is maximum in a range where the first end wiring portion exists in the direction perpendicular to the main surface.

10. A method for manufacturing an inductor component, comprising:
forming a laminate having a rectangular parallelepiped shape, by using a conductive paste including metal powder and an insulating paste having an insulating property, the laminate including:
a pattern of the conductive paste extending spirally inside the insulating paste,
a first conductive portion of the conductive paste connected to a first end of the pattern and exposed from the insulating paste, and
a second conductive portion of the conductive paste connected to a second end of the pattern and exposed from the insulating paste;
firing the laminate to form an element body including a first buried electrode in which the first conductive portion is sintered and a second buried electrode in which the second conductive portion is sintered; and
plating surfaces of the first buried electrode and the second buried electrode exposed to a surface of the element body to form a first covering electrode covering the surface of the first buried electrode and a second covering electrode covering the surface of the second buried electrode,
when one of six outer surfaces of the element body is defined as a bottom surface, one of surfaces perpendicular to the bottom surface is defined as a main surface, and surfaces perpendicular to both the bottom surface and the main surface are defined as a first end surface and a second end surface,
the first buried electrode and the second buried electrode are exposed to an outside of the element body on the bottom surface, and
the first buried electrode includes an end surface electrode portion exposed to the outside of the element body at the first end surface, and
in the plating,
a geometric center of the first end surface is covered with a cover having an insulating property, and
plating is performed by exposing a portion of the end surface electrode portion on a main surface side with respect to the geometric center from the cover on a virtual line that passes through the geometric center of the first end surface and is perpendicular to the main surface.
